(19) United States
(12) Patent Application Publication
(10) Pub. No.: US 2020/0207996 A1
(43) Pub. Date: Jul. 2, 2020

(54) INK JET INK COMPOSITION, INK JET PRINTING METHOD, AND INK JET PRINTING APPARATUS

(71) Applicant: Seiko Epson Corporation, Tokyo (JP)

(72) Inventor: Masahiro YATAKE, Shiojiri (JP)

(21) Appl. No.: 16/727,062

(22) Filed: Dec. 26, 2019

(30) Foreign Application Priority Data
Dec. 27, 2018 (JP) 2018-245530
Aug. 30, 2019 (JP) 2019-158581

(51) Int. Cl. C09D 11/107; C09D 11/322; C09D 11/36; C09D 11/102; B41M 5/00; B41J 11/00

(52) U.S. Cl. CPC C09D 11/107; C09D 11/322; B41J 11/002; C09D 11/102; B41M 5/0023; C09D 11/36

(57) ABSTRACT

An ink jet ink composition contains a pigment, a pigment dispersant resin, polymer particles, and the water. The total content of the pigment, the pigment dispersant resin, the polymer particles, and the water is 95.0% or more relative to the total mass of the ink jet ink composition.

The present application is based on, and claims priority from, JP Application Serial Number 2018-245530, filed Dec. 27, 2018 and JP Application Serial Number 2019-158581, filed Aug. 30, 2019, the disclosures of which are hereby incorporated by reference herein in their entirety.

### BACKGROUND

### 1. Technical Field

The present disclosure relates to an ink jet ink composition, an ink jet printing method, and an ink jet printing apparatus.

### 2. Related Art

Ink jet printing methods are used for industrial printing, including printing letters or characters, diagrams, or the like. In the field of flexible packaging, plastic films, such as polyethylene films, polypropylene films, polyethylene terephthalate films, and nylon films, are used as printing media. Printing on such a medium with an aqueous ink may result in insufficient adhesion between the image and the medium. It is desirable to achieve printing quality equivalent to the quality of gravure printing or offset printing by using aqueous ink.

Recent improvement in ink jet technology is likely to enable the use of aqueous ink in the flexible packaging field. Highly developed color and high fastness (to rubbing, light, ozone, water, etc.) are desirable in the flexible packaging field as well, and various approaches have been made to respond to such demands. There is a demand of individuals or shopkeepers for small-lot, low-cost printing on films or bags according to their preferences, even if the printing quality is not so high as the quality of gravure printing or offset printing.

For example, for presenting any information, such as imagery, description, or indication, on a standard bag or the like, a sticky label on which the information is printed is often put on the bag rather than directly printing the information on the bag. Although direct printing on the bag can lead to significantly reduced cost and labor, a printer enabling such printing with satisfactory quality has not yet been available.

Aqueous ink used in the flexible packaging filed often contains a pigment from the viewpoint of increasing the color development and the fastness of the printed image. In ink jet printing using aqueous pigment ink, the printing head tends to be clogged. Accordingly, the ink used in ink jet printing often contains a moisturizing agent in a high proportion from the viewpoint of reducing clogging.

For example, JP-A-2014-177516 discloses an idea using 10% to 40% of a solvent having a boiling point of 285° C. or more; JP-A-2008-266598 discloses an idea using 10% to 60% of water; JP-A-2004-143272 discloses an idea using 10% of 1,2-hexanediol as an alkanediol and 10% of glycerin; and JP-A-2014-101517 discloses an idea using water and 15% to 45% of an organic solvent. As disclosed in these, when an aqueous pigment ink is used, clogging is generally prevented by adding 10% or more of solvent to the ink.

Inks containing an organic solvent with high content, however, may not be easy to dry on a plastic film. In a case in practice, a large energy was used for drying ink. Thus, it has been difficult to provide a small printer suitable for individuals and shopkeepers to use. More specifically, when an ink containing an organic solvent with high content is applied onto a plastic film, the organic solvent is likely to remain on the film, and a large energy is used by post-heating to remove the organic solvent. Thus, the structure of the printer becomes extensive and complicated.

An ink jet ink composition is desirable that can be completely dried by only using a platen heater and/or a small heating mechanism when applied onto a plastic film. Also, an ink jet printing method and an ink jet printing apparatus are desirable that can dry the ink jet ink on a plastic film by only using a platen heater and/or a small heating mechanism.

### SUMMARY

According to an aspect of the present disclosure, there is provided an ink jet ink composition containing a pigment, a pigment dispersant resin, polymer particles, and water. The total content of the pigment, the pigment dispersant resin, the polymer particles, and the water is 95.0% by mass or more relative to the total mass of the ink composition.

In ink jet ink composition, the polymer particles may contain a resin selected from the group consisting of urethane resin, urea resin, acrylic resin, and styrene-acrylic resin.

The ink jet ink composition may further contain 0.1% by mass to 1.0% by mass of a surfactant relative to the total mass of the ink composition.

The ink jet ink composition may further contain 1.0% by mass to 5.0% by mass of an organic solvent relative to the total mass of the ink composition. The organic solvent has a boiling point of more than 100.0° C. at 1.0 atmosphere.

In the ink jet ink composition, the organic solvent may be 1,2-hexanediol or propylene glycol.

The ink jet ink composition may have a viscosity of 1.0 mPa·s to 3.0 mPa·s at 20.0° C.

In the ink jet ink composition, the water content may be 85.0% by mass or more relative to the total mass of the ink composition.

The ink jet ink composition may be ejected from an ink jet printing apparatus including a printing head that has a pressure chamber and a circulation path through which the ink jet ink composition in the pressure chamber is circulated.

In the ink jet ink composition, the ink jet ink composition may be circulated in an amount of 0.05 to 20.0 relative to a maximum amount of the ink jet ink composition to be ejected from the printing head.

The ink jet ink composition may undergo in-printing micro-vibration or out-of-printing micro-vibration when being in the pressure chamber.

According to another aspect of the present disclosure, there is provided an ink jet printing method including ejecting the ink jet ink composition from a printing head to apply the ink composition onto a printing medium.

Furthermore, an ink jet printing apparatus is provided. The ink jet printing apparatus includes the ink jet ink composition, and a printing head operable to eject the ink jet ink composition to apply the ink composition onto a printing medium.

The ink jet printing apparatus may further include a platen heater.

### BRIEF DESCRIPTION OF THE DRAWINGS

FIG. 1 is a schematic diagram of an ink jet printing apparatus used in an ink jet printing method according to an embodiment of the present disclosure.

FIG. 2 is a schematic diagram of the carriage and the vicinity of an ink jet printing apparatus used in an ink jet printing method according to an embodiment of the present disclosure.

FIG. 3 is a block diagram of an ink jet printing apparatus used in an ink jet printing method according to an embodiment of the present disclosure.

FIG. 4 is a schematic sectional view of the printing head of an ink jet printing apparatus.

FIG. 5 is a schematic sectional view of the circulation chamber and the vicinity thereof in the printing head.

FIGS. 6A and 6B are waveform diagrams illustrating driving signals.

FIG. 7 is a timing chart of driving signal generation for printing.

### DESCRIPTION OF EXEMPLARY EMBODIMENTS

Some embodiments of the present disclosure will now be described. The following embodiments will be described by way of example. The implementation of the subject matter of the disclosure is not limited to the following embodiments, and various modifications may be made within the scope and spirit of the disclosure. All the components disclosed in the following embodiments are not necessarily essential for the subject matter disclosed herein.

### 1. Ink Jet Ink Composition

An ink jet ink composition according to an embodiment of the present disclosure contains a pigment, a pigment dispersant resin, polymer particles, and water. The total content of the pigment, the pigment dispersant resin, the polymer particles, and the water is 95.0% by mass or more or 97% by mass or more relative to the total mass of the ink jet ink composition.

If the total content of the pigment, the pigment dispersant resin, the polymer particles, and waster is less than 95.0% by mass, the ink jet ink composition to which an organic solvent or a surfactant is further added may not be sufficiently dried. For example, the ink jet ink composition containing an organic solvent having a higher boiling point than water in a large proportion tends to be not easy to dry, and the ink jet ink composition containing an organic solvent having a lower boiling point than water in a large proportion is easy to dry at the ends of the nozzles of the printing head, likely to cause clogging of the nozzles. Either case is not undesirable. Beneficially, constituents other than the major constituents accounting for 95.0% or more of the ink jet ink composition are soluble in water and have a higher boiling point than water.

### 1. 1. Polymer Particles

The ink jet ink composition disclosed herein contains polymer particles. The content thereof is set so that the total content of the pigment, the pigment dispersant resin, the polymer particles, and the water can be 95.0% by mass or more relative to the total mass of the ink jet ink composition.

The polymer particles may be, but are not limited to, particles of polyurethane, acrylic resin, and/or styrene-acrylic resin. Such polymer particles tend to impart a sufficient adhesion to the printed image with the printing medium.

### 1. 1. (1-1) Polyurethane

Polymer particles made of polyurethane will now be described as the polymer particles that may be used in the ink jet ink composition. Polyurethane is a resin produced by polymerization using a polyisocyanate, more specifically using at least a polyisocyanate and a polyol and/or a polyamine and optionally a further polyol or polyamine as a crosslinking agent or a chain extending agent.

The polyurethane contains at least one of the urethane bond (urethane group) formed by a reaction of an isocyanate group and a hydroxy group and the urea bond (urea group) formed by a reaction of an isocyanate group and an amino group and may be linear or branched.

A polyurethane mentioned herein may be thermoplastic regardless of the presence or absence of a cross-linked structure or may be a cross-linked structure having no or substantially no glass transition temperature (Tg) or melting point.

The isocyanate group to form a urethane bond is supplied from a compound having an isocyanate group. Also, the hydroxy group to form the urethane bond is supplied from a compound having a hydroxy group. For higher polymerization, a compound having at least two isocyanate groups and a compound having at least two hydroxy groups are selected as the compound having an isocyanate group and the compound having a hydroxy group, respectively.

In the description herein, the compound having at least two isocyanate groups may be referred to as polyisocyanate, and the compound having at least two hydroxy groups may be referred to as polyol. In particular, the compound having two isocyanate groups may be referred to as diisocyanate, and the compound having two hydroxy groups may be referred to as diol.

The molecular chain between two isocyanate groups of polyisocyanate, the molecular chain between two hydroxy groups of polyol, and the molecular chain between two amino groups of polyamine are not involved in the formation of the urethane bond or the urea bond of the polyurethane. In the description herein, the entirety or a part of the molecular structure of the polyurethane other than the urethane bond or the urea bond may be referred to as the skeleton of the polyurethane. The skeleton may be linear or branched.

The polyurethane may contain other bonds or linkage apart from the urethane bond or the urea bond. Examples of such bonds include urea bonds formed by a reaction between a plurality of isocyanate bonds and water, a biuret bond formed by a reaction between a urea bond and an isocyanate group, an allophanate bond formed by a reaction between a urethane bond and an isocyanate group, an uretdione bond formed by dimerization of isocyanate groups, and an isocyanurate bond formed by trimerization of isocyanate groups. Such bonds can be actively formed or be inhibited from forming by, for example, controlling reaction temperature. Thus, a polyisocyanate containing such bonds other than the urethane bond or the urea bond may be formed produced under the condition where, for example, polyisocyanate, polyol, and polyamine are present in a reaction system. The presence of the allophanate structure, the biuret structure, the uretdione structure, and the isocyanurate structure may enhance the adhesion of the ink jet ink composition to the printing medium and the strength of the coating, accordingly increasing the rub fastness.

In the description herein, the amine having at least two amino groups is referred to as polyamine similarly to the designations of polyisocyanate and polyol.

### 1. 1. (1-2) Constituents of Polyurethane

Polymer particles of polyurethane (hereinafter referred to as polyurethane polymer particles) are a reaction product of polyisocyanate and an active hydrogen compound. The polymer particles used in the ink jet ink composition disclosed herein are produced by polymerization using at least a diisocyanate and a polyol and may be polymerized by further using a polyamine. Optionally, a further polyol or polyamine may be used as a crosslinking agent or a chain extending agent.

The polyisocyanate may be a polyisocyanate monomer or a polyisocyanate derivative. Examples of the polyisocyanate monomer include aromatic polyisocyanate, alicyclic polyisocyanate, and aliphatic polyisocyanate.

Examples of the aromatic polyisocyanate include 2,4- and 2,6-tolylene diisocyanates and a mixture thereof (TDI), m- and p-phenylene diisocyanates and a mixture thereof, 4,4′-diphenyl diisocyanate, 1,5-naphthalene diisocyanate (NDI), 4,4′-, 2,4′-, and 2,2′-diphenyl methane diisocyanates and a mixture thereof (MDI), 4,4′-toluidine diisocyanate (TODI), 1,3- and 1,4-bis(isocyanatomethyl)benzene and a mixture thereof (XDI), 1,3- and 1,4-bis(isocyanatopropyl)benzene and a mixture thereof (TMXDI), and ω,ω′-diisocyanato-1,4-diethylbenzene.

Examples of the alicyclic polyisocyanate include 1,3-cyclopentane diisocyanate, 1,3-cyclopentene diisocyanate, 1,4-cyclohexane diisocyanate, 1,3-cyclohexane diisocyanate, isophorone diisocyanate (IPDI), 4,4′-, 2,4′-, and 2,2′-dicyclohexylmethane isocyanates, methyl-2,4-cyclohexane diisocyanate, methyl-2,6-cyclohexane diisocyanate, norbornane diisocyanates (isomers and a mixtures thereof, NBDI), 1,3- and 1,4-bis(isocyanatomethyl) cyclohexanes and a mixture thereof (H6XDI).

Examples of the aliphatic polyisocyanate include ethylene diisocyanate, trimethylene diisocyanate, 1,2-propylene diisocyanate, tetramethylene diisocyanate, 1,2-butylene diisocyanate, 2,3-butylene diisocyanate, 1,3-butylene diisocyanate, 1,5-pentamethylene diisocyanate (PDI), and 1,6-hexamethylene diisocyanate (HDI). Such polyisocyanate monomers may be used individually or in combination.

Examples of the polyisocyanate derivative include multimers, allophanate-modified forms, of the polyisocyanate monomer, polyol-modified forms, biuret-modified forms, urea-modified forms, oxadiazine-modified forms, carbodiimide-modified forms, uretdione-modified forms, and uretonimine-modified forms of the polyisocyanate monomer.

The polyisocyanate derivative may be polymethylene polyphenylene polyisocyanate (which is also referred to as polymeric MDI or crude MDI). In some embodiments, the polyisocyanate may be at least one selected from the group consisting of dicyclohexylmethane diisocyanate, isophorone diisocyanate, 1,3-bis(isocyanatomethyl)cyclohexane, 1,3-bis(isocyanatopropyl)benzene, and 1,3-bis(isocyanatomethyl)benzene.

The dicyclohexylmethane diisocyanate may be dicyclohexylmethane-4,4′-diisocyanate, dicyclohexylmethane-2,2′-diisocyanate, dicyclohexylmethane-2,4′-diisocyanate, or a mixture thereof. In an embodiment, the polyisocyanate may be a multifunctional polyisocyanate that is a dimer or higher multimer formed by any combination of the above-cited polyisocianates. The multifunctional polyisocyanate contains two or more polyisocyanate molecules and has two or more isocyanate groups at the ends of the molecule thereof to react with the OH group of polyol and/or the NH₂ group of polyamine. Such a multifunctional polyisocyanate may have at least one structure selected from the group consisting of the allophanate structure, the uretdione structure, the isocyanurate structure, and the biuret structure.

The multifunctional polyisocyanate is a monomeric diisocyanate or a polymeric structure including two or more polyisocyanate molecules and may have many branches in the molecule. Polymers containing such a multifunctional polyisocyanate have a structure in which the molecules are intricately intertwined and are in a state in which urethane bonds are dense. Therefore, such a polymer is kept well dispersed in the aqueous ink jet ink composition in spite of having a relatively low acid value. Such a polyisocyanate enhances the adhesion of the image to plastic films on which the image is formed.

Also, such a polyisocyanate may increase the strength of the coating of the ink composition, accordingly increasing rub fastness. In particular, the use of an alicyclic polyisocyanate may lead to a further increased strength of the coating and a further increased rub fastness. The polyisocyanate may be a mixture of different polyisocyanates.

The polyisocyanate may have a structure including two or more polyisocyanate molecules. The structure including two or more polyisocyanate molecules may be the uretdione structure or the isocyanurate structure. Such a polyisocyanate results in a polyurethane having a structure in which the molecules are intricately intertwined and are in a state in which urethane bonds are dense. Therefore, the urethane is kept well dispersed in the aqueous ink jet ink composition in spite of having a low acid value.

The polyurethane skeleton mentioned herein refers to the molecular chain between the functional groups of the polyurethane. Hence, the polymer of the polymer particles used in some embodiments of the present disclosure has a skeleton formed from the raw materials, such as a polyisocyanate, a polyol, and a polyamine. In an embodiment, the skeleton may be, but is not limited to, a substituted or unsubstituted saturated, unsaturated, or aromatic chain. Such a chain may have, for example, a carbonate bond, an ester bond, or an amide bond. In such a skeleton, the form and the number of the substituents are not particularly limited, and examples of the substituent include alkyl, hydroxy, carboxy, amino, sulfonyl, and phosphonyl.

The polyurethane polymer particles used in the ink jet ink composition of some embodiments of the present disclosure may be produced by using a polyol as one of the constituents. The polyol is a bifunctional or higher functional compound, that is, a compound having two or more hydroxy groups and is not otherwise limited. The polyol may be an alkylene glycol, a polyester polyol, a polyether polyol, or a polycarbonate polyol.

Examples of the alkylene glycol include ethylene glycol, diethylene glycol, triethylene glycol, tetraethylene glycol, polyethylene glycol, 1,2-propylene glycol, 1,3-propanediol, tripropylene glycol, polypropylene glycol, poly(tetramethylene glycol), hexamethylene glycol, tetramethylene glycol, neopentyl glycol, 1,2-butanediol, 1,3-butanediol, 1,4-butanediol, 1,2-pentanediol, 1,5-pentanediol, 1,2-hexanediol, 1,6-hexanediol, 3-methyl-1,5-pentanediol, 1,2-cyclohexanediol, 1,4-cyclohexanediol, 1,4-cyclohexanedimethanol, 4,4-dihydroxyphenylpropane, 4,4-dihydrocyphenylmethane, glycerin, trimethylolethane, trimethylolpropane, 1,2,5-hexanetriol, 1,2,6-hexanetriol, pentaerythritol, trimethylol melamine, polyoxypropylene triol, dimethyl-1,3-pentanediol, diethyl-1,3-pentanediol, dipropyl-1,3-pentanediol, dibutyl-1,3-pentanediol, and 2-butyl-2-ethyl-1,3-propanediol.

When the polyurethane is produced by using an alkylene glycol as one of the materials, the alkylene glycol, which has a low molecular weight, may enter the three-dimensional network structure formed in the polyurethane and react with the isocyanate to form urethane bonds, thus forming a durable coating. Consequently, the strength of the coating (image) may increase to enhance the rub fastness.

The polyester polyol may be anester. Acids that can form the ester include aliphatic dicarboxylic acids, such as malonic acid, succinic acid, tartaric acid, oxalic acid, glutaric acid, adipic acid, pimelic acid, suberic acid, azelaic acid, sebacic acid, alkyl succinic acids, linolenic acid, maleic acid, fumaric acid, mesaconic acid, citraconic acid, and itaconic acid; and alicyclic dicarboxylic acids, such as phthalic acid, naphthalenedicarboxylic acid, biphenyldicarboxylic acid, tetrahydrophthalic acid, and hydrogenated aromatic compounds. An anhydride, a salt, an alkyl ester, an acid halide of such acids may be used as the acid component of the ester. The alcohol that can form the ester may be, but is not limited to, any of the above-cited diols.

The polyether polyol may be an addition polymer of an alkylene oxide or a condensation polymer of polyols, such as polyalkylene glycols. Examples of the alkylene oxide include ethylene oxide, propylene oxide, butylene oxide, and α-olefin oxide. Examples of the polyalkylene glycols include polyethylene glycol (polyoxyethylene), polypropylene glycol (polyoxypropylene), and polybutylene glycol. In particular, polypropylene glycol enhances the flexibility of the polyurethane, and the coating formed by printing on a plastic film exhibits improved rub fastness and gloss. Polypropylene glycol is commercially available, and examples thereof include EXCENOL series produced by AGC, NEWPOL PP produced by Sanyo Chemical, and UNIOL D series produced by NOF Corporation.

Polycarbonate diol has a molecular chain including two hydroxy groups and a carbonate bond.

Polycarbonate diol, which may be used as a portion or the entirety of the polyol, can be produced by a reaction of a carbonate, such as an alkylene carbonate, a diaryl carbonate, or a dialkyl carbonate, with phosgene and an aliphatic polyol. Alternatively, an alkanediol-based polycarbonate diol, such as poly(hexamethylene carbonate) diol, may be used. The polycarbonate diol that is a starting material of the polyurethane tends to increase the resistance to heat and hydrolysis of the resulting polyurethane.

By using a polycarbonate diol as the polyol, the resulting polyurethane has a skeleton derived from the polycarbonate diol. Such a skeleton enhances the rub fastness of the coating of the ink composition.

Polycarbonate diols, which are beneficial as one of the materials of the polyurethane used in some embodiments of the present disclosure, generally have two hydroxy groups in the molecule and can be produced by a transesterification reaction of a diol and a carbonic acid ester. Examples of such a diol include 1,4-butanediol, 1,3-butanediol, 1,2-butanediol, 1,5-pentanedioil, 1,2-pentanediol, 1,6-hexanediol, 1,5-hexanediol, 1,2-hexanediol, 1,7-heptanediol, 1,8-octanediol, 1,2-octanediol, 1,9-nonanediol, 1,10-decanediol, neopentyl glycol, 4-methyl-1,5-pentanediol, 2-methyl-1,3-propanediol, 2-methyl-1,8-octanediol, 2-isopropyl-1,4-butanediol, 2-ethyl-1,6-hexanediol, 3-methyl-1,5-pentanediol, 2,4-dimethyl-1,5-pentanediol, 2,4-diethyl-1,5-pentanediol, 2-ethyl-1,3-hexanediol, 2-butyl-2-ethyl-1,3-propanediol, 1,4-cyclohexane dimethanol, 1,3-cyclohexanediol, and 1,4-cyclohexanediol. Such diols may be used individually or in combination. Among such diols neopentyl glycol, 4-methyl-1,5-pentanediol, 2-methyl-1,3-propanediol, 2-methyl-1,8-octanediol, 2-isopropyl-1,4-butanediol, 2-ethyl-1,6-hexanediol, 3-methyl-1,5-pentanediol, 2,4-dimethyl-1,5-pentanediol, and 2,4-diethyl-1,5-pentanediol are unlikely to crystallize and are therefore beneficial.

The carbonic acid ester used for producing the polycarbonate diol is not limited provided that the resulting ink composition enables favorable printing on plastic films and may be a dialkyl carbonate, a diaryl carbonate, or an alkylene carbonate. In some embodiments, a diaryl carbonate may be used in view of reactivity. Examples of such a carbonate include dimethyl carbonate, diethyl carbonate, dibutyl carbonate, diphenyl carbonate, and ethylene carbonate. In some embodiments, diphenyl carbonate may be selected.

Some polycarbonate diols are commercially available, and examples thereof include Mitsubishi Chemical BENEBiOL series: NL1010DB, NL2010DB, NL3010DB, NL1010B, NL2010B, NL3010B, NL1050DB, NL2050DB, and NL3050DB; Asahi Kasei DURANOL series; Tosoh NIPPOLAN series; Kuraray Poly Hexanediol Carbonate; Daicel PLACCEL CD205PL; and Ube Industries ETERNACOLL series.

In some embodiments, the polyol used as one of the materials of the polyurethane may contain an acid group in the molecule. Examples of the acid group-containing diol include dimethylolacetic acid, dimethylolpropionic acid, dimethylolbutanoic acid, and dimethylolbutyric acid. In some embodiments, dimethylolpropionic acid or dimethylolbutanoic acid may be selected. For an aqueous ink jet ink composition, the polyurethane may be polymerized by using such an acid group-containing diol as one of the materials.

For polymerization of the polyurethane using a polypropylene glycol and/or a polycarbonate diol as one of the materials, the individual weight average molecular weight thereof may be from 500 to 3000. Polypropylene glycols and polycarbonate diols having a weight average molecular weight of 500 or more do not excessively increase the urethane bond density of the resulting polyurethane, and the molecular chain derived from the polypropylene glycol and/or the polycarbonate diol thus maintains an appropriate elasticity or flexibility. Accordingly, the flexibility of the polyurethane and consequently the rub fastness of the coating are increased. Also, the polypropylene glycols and/or polycarbonate diol individually having a weight average molecular weight of 3000 or less, which is to react with the polyisocyanate, do not excessively reduce the urethane bond density of the resulting polyurethane, and the molecular chain derived from the polypropylene glycol and/or polycarbonate diol thus maintains such an appropriate extensibility as to suppress tackiness and ensure a rub fastness. Thus, the polypropylene glycol and/or polycarbonate diol having a weight average molecular weight of 500 to 3000 enables the polyurethane to form a coating (image) having an appropriate strength and flexibility in favorable balance, consequently increasing the rub fastness of the printed image. Accordingly, the polycarbonate diol having a weight average molecular weight of 500 to 3000 enables the polyurethane to form a coating having an appropriate strength and flexibility in favorable balance, and, consequently, the printed image has a high-level rub fastness.

The polymer (polyurethane) synthesized by using the above-described constituents includes two segments: a hard segment and a soft segment. The hard segment is formed of a polyisocyanate, a short-chain polyol, a polyamine, and a crosslinking agent or chain extending agent, being mainly involved in the strength of the polyurethane. The soft segment is formed of a long-chain polyol and is mainly involved in the flexibility of the resin. In the polyurethane coating formed by applying the ink jet ink composition on a printing medium, such hard segments and soft segments form a microphase separation structure that can impart both a strength and a flexibility and consequently a high elasticity to the coating. These properties of the coating lead to an increased rub fastness of the printing item.

In an embodiment, the materials of the polymer particles used in the ink jet ink composition may include a polyamine. The polyamine contains two or more amino groups and is not otherwise limited.

Examples of the polyamine include aliphatic diamines, such as ethylenediamine, propylenediamine, 2,2-dimethyl-1,3-propanediamine, 2-methyl-1,5-pentanediamine, trimethylhexanediamine, 2-butyl-2-ethyl-1,5-pentanediamine, 1,8-octanediamine, 1,9-nonanediamine, and 1,10-decanediamine; diethylenetriamine, hexylenediamine, triethylenetetramine, tetraethylenepentamine, isophorone diamine, xylylenediamine, diphenylmethanediamine, hydrogenated diphenylmethanediamine, hydrazine, polyamide polyamine, polyethylene polyimine, 1-amino-3-aminomethyl-3,5,5-trimethylcyclohexane, dicyclohexylmethanediamine, bicycloheptanedimethaneamine, mensendiamine, diaminodicyclohexylmethane, isopropylidene cyclohexyl-4,4′-diamine, 1,4-diaminocyclohexane, and 1,3-bisaminomethylcyclohexane.

Many of the compounds generally used as polyamine have a molecular weight approximately equivalent to that of short-chain polyols and are basically formed into the urea group or the biuret group that is the hard segment of the polyurethane. The resulting polymer containing the urea group may be called urea resin.

The polyamine may be used as a component to react with a multifunctional polyisocyanate, a chain extending agent, or a crosslinking agent or may be brought into a reaction of the amino group with an isocyanate group to form a urea bond. If a polyamine is used, the amount thereof may be adjusted for a predetermined urea group/urethane group ratio to control the physical properties of the polyurethane.

In an embodiment, the polyurethane polymer particles used in the ink jet ink composition may contain a crosslinking agent and/or a chain extending agent.

The crosslinking agent is used for synthesizing a prepolymer, and the chain extending agent is used for a chain extending reaction after the prepolymer synthesis. The crosslinking agent and the chain extending agent are selected from among the above-cited polyisocyanates, polyols, and polyamines, depending on the intended use of the crosslinking agent, the chain extending agent, and the like.

The chain extending agent is, for example, a compound to react with isocyanate groups of the polyisocyanate not forming the urethane bond. The chain extending agent may be any of the above-cited polyols and polyamines. The chain extending agent may be a compound capable of forming crosslinks in the polyurethane. The compound that can be used as the chain extending agent may be a low-molecular weight polyol or polyamine having a number average molecular weight of less than 500.

The crosslinking agent may be a trifunctional or higher functional polyisocyanate, polyol, or polyamine. Examples of the trifunctional or higher functional polyisocyanate include polyisocyanates having an isocyanurate structure and polyisocyanates having an allophanate or biuret structure. Examples of the trifunctional or higher functional polyol include glycerin, trimethylolpropane, pentaerythritol, and polyoxypropylene triol. Examples of the trifunctional or higher functional polyamine include trialcoholamines, such as triethanolamine and triisopropanolamine, and amines having three or more amino groups, such as diethylenetriamine and tetraethylenepentaamine.

Whether the polyurethane is crosslinked or not can be determined based on the gel fraction defined by the ratio of gel to sol under a phenomenon in which crosslinked polyurethane swells without dissolving in solvent. The term gel fraction is a measure of the degree of crosslinking of polyurethane, measured based on the solubility of cured polyurethane. In general, the higher the degree of crosslinking, the higher the gel fraction.

### 1. 1. (1-3) Synthesis of Polyurethane Polymer Particles

The polyurethane polymer particles can be produced by a known process. An exemplary process will be described below. A polyisocyanate and at least one compound capable of reacting with the polyisocyanate (a polyol and, optionally, a polyamine or the like) are brought into a reaction in a higher proportion of isocyanate groups to synthesize a prepolymer having isocyanate groups at the ends of the molecule. In this reaction, an organic solvent having a boiling point of 100° C. or less and having no groups capable of reacting with the isocyanate group, such as methyl ethyl ketone, acetone, or tetrahydrofuran, may be used if necessary. Such a reaction is generally called a prepolymer process.

If an acid group-containing diol is used as one of the materials, the acid group of the prepolymer is neutralized by using a compound capable of acting as a counter ion to the acid group, such as an organic base, for example, N,N-dimethylethanolamine, N,N-diethylethanolamine, diethanolamine, triethanolamine, triisopropanolamine, trimethylamine, or triethylamine, or an inorganic base, for example, sodium hydroxide, potassium hydroxide, or ammonia. In some embodiments, a neutralizer containing an alkali metal, such as sodium hydroxide or potassium hydroxide is used to increase the stability of polyurethane dispersion. Such a neutralizer may be used in a proportion of 0.5 mol to 1.0 mol or 0.8 mol to 1.0 mol relative to 1 mol of the acid group of the prepolymer. In this instance, the viscosity of the reaction system is unlikely to increase, and favorable workability is ensured accordingly.

Then, the prepolymer is added into a liquid containing a chain extending agent or a crosslinking agent for a chain extending reaction or a crosslinking reaction. Subsequently, the solvent or medium is removed to yield polyurethane polymer particles. For an organic solvent, an evaporator or the like is used for removal.

A catalyst may be used for the polymerization of the polyurethane, and examples of the catalyst include titanium catalysts, aluminum catalysts, zirconium catalysts, antimony catalysts, germanium catalysts, bismuth catalysts, and metal complex-based catalysts. Exemplary titanium catalysts include tetraalkyl titanates, such as tetrabutyl titanate and tetramethyl titanate, and oxalic acid metal salts, such as titanium potassium oxalate. Other known catalysts may be used without particular limitation, including tin compounds, such as dibutyltin oxide and dibutyltin dilaurylate. A non-heavy metal catalyst may be used. In particular, it has long been known that acetylacetonate complexes of transition metals, such as titanium, iron, copper, zirconium, nickel, cobalt, and manganese, are active in urethanation. In view of increasing environmental awareness, less toxic catalysts that can be substituted for toxic heavy metal catalysts are demanded. In particular, the high urethanation activity of titanium and titanium compounds is increasingly being used. In the field of flexible packaging, the use of plastic films for food accounts for a large percentage of the applications of plastic films. Therefore, the use of toxic metal catalysts is expected to be reduced.

### 1. 1. (1-4) Acid Value of Polyurethane

The acid value of the polyurethane can be measured by titration. For example, the acid value is determined by measurement using a titrator AT610 manufactured by Kyoto Electronics Manufacturing Co., Ltd and calculation using the following equation (1):

Acid value (mg/g)=(EP1−BL1)×FA1×C1×K1/SIZE (1)

wherein EP1 represents the volume (mL) of the titrant added, BL1 represents the blank value (0.0 mL), FA1 represents the factor of the titrant (1.00), C1 represents a concentration conversion factor (5.611 mg/mL) equivalent to 1 mL of 0.1 mol/L potassium hydroxide (KOH), K1 represents a coefficient (1), and SIZE represents the weight (g) of the analyte.

The polymer (polyurethane) is dissolved in tetrahydrofuran, and the polymer solution is subjected to potentiometric colloid titration to measure the acid value. For this titration, the titrant may be a sodium hydroxide solution in ethanol.

In some embodiments, the acid value of the polyurethane of the polymer particles, which can be measured as described above, may be 5 mg KOH/g to 200 mg KOH/g. In another embodiment, the acid value may be 7 mg KOH/g to 100 mg KOH/g or 8 mg KO/g to 50 mg KOH/g. Polymer particles having an acid value of 5 mg KOH/g or more can disperse stably in the aqueous ink, and such an aqueous ink is unlikely to cause clogging even at high temperature. Also, polymer particles having an acid value of 200 mg KOH/g or less are unlikely to be swollen with water, and, accordingly, the ink jet ink composition does not thicken readily. In addition, the resulting printed item can keep the water resistance high.

The acid value of the polyurethane can be varied by, for example, adjusting the content of the skeleton derived from a carboxy-containing glycol (acid group-containing polyol, such as dimethylolpropionic acid). In at least some embodiments of the ink jet ink composition, the polyurethane of the polymer particles is a carboxy-containing polyurethane produced by polymerization using a carboxy-containing glycol from the viewpoint of easy dispersion of the polymer particles.

In an embodiment, the polymer particles may include polyurea (urea resin) particles in addition to the polyurethane (urethane resin) particles. The polyurethane before being added to the ink composition is in the form of an emulsion.

1. 1. (2-1) Acrylic Resin and/or Styrene-Acrylic Resin

The polymer particles may be made of either one or both of acrylic resin and styrene-acrylic resin (hereinafter referred to as the acrylic and/or styrene-acrylic resin). Such polymer particles will now be described. The acrylic and/or styrene-acrylic resin can be synthesized from, but not limited to, starting materials, such as acrylic monomer, oligomer, and other monomers such as styrene, using a radical polymerization initiator, a polymerization regulator, such as a chain transfer agent or a pH adjuster, and a dispersion medium.

The monomers that can be used in the synthesis of the acrylic and/or styrene-acrylic resin include (meth)acrylic acid alkyl esters, such as methyl (meth)acrylate, ethyl (meth)acrylate, n-butyl (meth)acrylate, isobutyl (meth)acrylate, tert-butyl (meth)acrylate, n-propyl (meth) acrylate, n-hexyl (meth) acrylate, 2-ethylhexyl (meth)acrylate, n-octyl (meth)acrylate, isooctyl acrylate, isodecyl (meth)acrylate, lauryl (meth)acrylate, cetyl (meth)acrylate, stearyl (meth)acrylate, and isostearyl (meth)acrylate; and alicyclic (meth)acrylic acid esters, such as cyclohexyl (meth)acrylate and isobornyl (meth)acrylate. In an embodiment, a (meth)acrylic acid alkyl ester having a carbon number of 1 to 20, 1 to 12, or 1 to 8 may be used. Monomers as cited above may be used individually or in combination. In some embodiments, methyl methacrylate or n-butyl acrylate may be beneficial. In at least some embodiments, methyl methacrylate may be used from the viewpoint of improving the physical properties (resistance to ethanol and water) of the coating of the ink jet ink composition.

Alternatively, the monomer may be selected from among hydroxyalkyl (meth)acrylates, such as hydroxyethyl (meth)acrylate and hydroxypropyl (meth)acrylate, and hydroxy-containing ethylenically unsaturated monomers, such as polyethylene glycol (meth)acrylate and other polyalkylene glycol (meth)acrylates. Such monomers may be used individually or in combination. Beneficially, the monomer is selected from among hydroxyalkyl (meth)acrylates containing a hydroxyalkyl group having a carbon number of 2 to 4 and polyalkylene glycol (meth)acrylates containing an alkylene group having a carbon number of 2 to 4. In some embodiments, hydroxyethyl (meth)acrylate may be used.

Also, glycidyl (meth)acrylate, allyl glycidyl ether, or methylglycidyl (meth)acrylate may be used individually or in combination. Beneficial examples of such monomers include epoxy-containing ethylenically unsaturated monomers, such as glycidyl (meth)acrylate; methylol-containing ethylenically unsaturated monomers, such as N-methylol (meth)acrylate and dimethylol (meth)acrylate; N-methoxymethyl(meth)acrylamide and N-butoxymethyl(meth)acrylamide; alkoxyalkyl (meth)acrylates, such as methoxyethyl (meth)acrylate, methoxypropyl (meth)acrylate, ethoxyethyl (meth)acrylate, and ethoxypropyl (meth) acrylate; alkoxyalkyl-containing ethylenically unsaturated monomers, such as polyethylene glycol monomethoxy (meth)acrylate and other polyalkylene glycol monoalkoxy (meth) acrylates; cyano-containing ethylenically unsaturated monomers, such as (meth)acrylonitrile; di(meth)acrylates, such as divinylbenzene, polyoxyethylene di(meth)acrylate, polyoxypropylene di(meth)acrylate, neopentyl glycol di(meth)acrylate, and butanediol di(meth)acrylate; tri(meth)acrylates, such as trimethylolpropane tri(meth)acrylate; ethylenically unsaturated monomers containing two or more radically polymerizable double bonds, such as pentaerythritol tetra(meth)acrylate and other tetra(meth)acrylates; amino-containing ethylenically unsaturated monomers, such as N,N-dimethylaminomethyl (meth)acrylate and N,N-diethylaminoethyl (meth)acrylate; and aromatic ring-containing ethylenically unsaturated monomers, such as styrene, α-methylstyrene, benzyl (meth)acrylate, and phenoxyethyl (meth)acrylate.

In order to disperse the acrylic and/or styrene-acrylic resin in water, the acid group-containing monomer is added as a monomer in the polymerization of the resin. The acid group-containing monomer is a carboxy-containing monomer, such as (meth)acrylic acid. In some embodiments, methacrylic acid may be added.

Examples of the polymerization initiator include organic peroxides, such as alkyl peroxides, t-butyl hydroperoxide, cumene hydroperoxide, p-methane hydroperoxide, lauroyl peroxide, 3,5,5-trimethylhexanoyl peroxide, octanoyl peroxide, t-butyl cumyl peroxide, benzoyl peroxide, dichlorobenzoyl peroxide, dicumyl peroxide, di-t-butyl peroxide, 1,1-bis(t-butylperoxy)-3,3,5-trimethylcyclohexane, 3,3,5-trimethylcyclohexanone peroxide, methylcyclohexanone peroxide, diisobutyl peroxydicarbonate, di-2-ethylhexyl peroxydicarbonate, and t-butyl peroxyisobutyrate; and 2,2′-azobisisobutyronitrile, dimethyl-2,2′-azobisisobutyrate, 2,2′-azobis(2,4-dimethylvaleronitrile), 2,2′-asobis(2-methylbutyronitrile), potassium persulfate, sodium persulfate, ammonium persulfate, hydrogen peroxide, 4,4′-azobis-4-cyanovaleric acid ammonium (amine) salt, 2,2′-azobis(2-methylamidoxime) dihydrochloride, 2,2′-azobis(2-methylbutaneamidoxime) dihydrochloride tetrahydrate, 2,2′-azobis{2-methyl-N-[1,1-bis(hydroxymethyl)-2-hydroxyethyl]propionamide}, and 2,2′-azobis[2-methyl-N-(2-hydroxyethyl)propionamide].

Such polymerization initiators may be used individually or in combination. Potassium persulfate and sodium peroxide are superior in terms of polymerization stability and, therefore, may be beneficially used.

The polymerization initiator may be used in a proportion of 0.01 part to 5.0 parts, beneficially 0.03 part to 3.0 parts or 0.02 part to 1.0 part, relative to the total mass (100 parts) of the monomers. If the amount of the polymerization initiator is excessively small, polymerization speed is likely to decrease; if the amount of the polymerization initiator is excessively large, the resulting polymer tends to have a low molecular weight, resulting in reduced water resistance.

The polymerization initiator may be previously contained in the polymerization system or may be added immediately before starting the polymerization. Also, the polymerization initiator may be further added during polymerization if necessary. Alternatively, the polymerization initiator may be mixed with the monomer material in advance or mixed into an emulsion of the monomer material. For addition or mixing, the polymerization initiator may be dissolved in a solvent or the monomer material, and, furthermore, the solution of the polymerization initiator may be brought into a state of emulsion.

The polymerization regulator may be, for example, a chain transfer agent or a pH adjuster. Examples of the chain transfer agent include mercaptans, such as n-dodecyl mercaptan, thioglycolic acid, octyl thioglycolate, and thioglycerol; alcohols, such as methanol, ethanol, propanol, and butanol; aldehydes, such as acetaldehyde, propionaldehyde, n-butyl aldehyde, furfural, and benzaldehyde. Such compounds may be used individually or in combination. In some embodiments, the chain transfer agent may be selected from mercaptans.

The chain transfer agent helps stabilize polymerization but may reduce the degree of polymerization of the acrylic and/or styrene-acrylic resin. Accordingly, it is beneficial to use the chain transfer agent in a proportion by weight of 0.01 part to 1 part, more beneficially 0.01 part to 0.5 part, relative to the total weight (100 parts) of the monomers. An excessively small amount of the chain transfer agent does not produce satisfactory effect. In contrast, if the amount of the chain transfer agent is excessively large, the resulting polymer becomes too soft, and the ink jet ink composition may not be consistently ejected and becomes likely to clog the nozzles of the head.

Examples of the pH adjuster include metal hydroxides, such as sodium hydroxide, potassium hydroxide, and lithium hydroxide; amines, such as triethylamine, trimethylamine, diethylethanolamine, triethanolamine, and triisopropanolamine; and salts having a buffer action, such as sodium acetate, ammonium acetate, sodium formate, ammonium formate, sodium carbonate, sodium hydrogencarbonate, potassium hydrogencarbonate, monosodium phosphate, monopotassium phosphate, disodium phosphate, and trisodium phosphate. Such compounds may be used individually or in combination.

The pH adjuster may be used in a proportion of 0.01 part to 10.0 parts, beneficially 0.1 part to 5.0 parts, relative to the total mass (100 parts) of the monomers. An excessively small amount of the pH adjuster tends not to produce a sufficient effect to regulate the polymerization, and an excessively large amount of the pH adjuster tends to hinder the reaction.

The acrylic and/or styrene-acrylic resin is dispersed in a medium, for example, an aqueous medium. The aqueous medium may be water, a water-based medium containing an alcoholic medium. In some embodiment, the aqueous medium is water.

1. 1. (2-2) Acid Value of the Acrylic and/or Styrene-Acrylic Resin

The acid value of the acrylic and/or styrene-acrylic resin is measure by titration as in the case of polyurethane.

1. 1. (2-3) Synthesis of the Acrylic and/or Styrene-Acrylic Resin

The acrylic and/or styrene-acrylic resin may be polymerized by emulsion polymerization. In the emulsion polymerization, monomers, a radical polymerization initiator, a polymerization regulator, a dispersion medium, and an emulsifier are mixed and stirred for emulsification of the monomers. The emulsified monomers are subjected to polymerization by heating. In some embodiments, a portion of the monomers may be gradually dropped for polymerization. In emulsion polymerization, the entire amount of the monomers is subjected to polymerization, generally at a temperature of 40° C. to 95° C. (beneficially 65° C. to 85° C.) over a period of 0.5 hour to 6 hours, at one time or by being divided into some aliquots. For polymerization, the compounds of the monomers or the dropping speed may be varied, or the monomers may be dropped by several stages for a multi-step polymerization reaction.

### 1. 1. (3) Polymer Particle Content

The polymer particles contained in the ink jet ink composition disclosed herein may further include other polymer particles in addition to the polyurethane polymer particles or the acrylic and/or styrene-acrylic polymer particles. Polymer particles made of different materials may be used in combination as such further polymer particles.

The total content of the polymer particles (solids only) in the ink jet ink composition may be, by mass, from 0.1% to 6.0% or from 1.0% to 5.0%. In the ink jet ink composition disclosed herein, the total content of the polymer particles is set so that the total mass of the pigment, the pigment dispersant resin, the polymer particles, and water can account for 95.0% or more of the total mass of the ink jet ink composition.

### 1. 2. Pigment

The ink jet ink composition disclosed herein contains a pigment as a coloring material. The pigment content is set so that total mass of the pigment, the pigment dispersant resin, the polymer particles, and water can account for 95.0% or more of the total mass of the ink jet ink composition.

In the ink jet ink composition containing the polymer particles, the pigment can be physically fixed to the printing medium. By fixing the pigment to the printing medium, an image (printed item) is created.

The pigment may be, but is not limited to, an inorganic pigment, such as carbon black, potassium carbonate, or titanium oxide, or an organic pigment, such as an azo pigment, an isoindolinone pigment, a diketopyrrolopyrrole pigment, a phthalocyanine pigment, a quinacridone pigment, or an anthraquinone pigment.

Examples of black pigments include No. 2300, No. 900, MCF 88, No. 33, No. 40, No. 45, No. 52, MA7, MA8, MA100, and No. 2200B (all produced by Mitsubishi Chemical Corporation); Raven 5750, Raven 5250, Raven 5000, Raven 3500, Raven 1255, and Raven 700 (all produced by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all produced by CABOT); and Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all produced by Degussa).

Examples of white pigments include C.I. Pigment Whites 1 (basic lead carbonate), 4 (zinc oxide), 5 (mixture of zinc sulfide and barium sulfate), 6 (titanium oxide), 6:1 (titanium oxide containing other metal oxides), 7 (zinc sulfide), 18 (calcium carbonate), 19 (clay), 20 (titanated mica), 21 (barium sulfate), 22 (natural barium sulfate), 23 (gloss white), 24 (alumina white), 25 (gypsum), 26 (magnesium oxide-silicon oxide), 27 (silica), and 28 (anhydrous calcium silicate).

Examples of yellow pigments include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of magenta pigments include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245 and C.I. Pigment Violets 19, 23, 32, 33, 36, 38, 43, and 50.

Examples of cyan pigments include C.I. Pigment Blues 1, 2, 3, 15, 15:1, 15:2, 15:3, 15:34, 15:4, 16, 18, 22, 25, 60, 65, and 66 and C.I. Vat Blues 4 and 60.

Pigments other than black, white, yellow, magenta, and cyan pigments include C.I. Pigment Greens 7 and 10, C.I. Pigment Browns 3, 5, 25, and 26, C.I. Pigment Oranges 1, 2, 5, 7, 13, 14, 15, 16, 24, 34, 36, 38, 40, 43, and 63.

The pigments cited above may be a surface-treated pigment defined by particles having surfaces to which an anionic group is bound directly or with another atomic group therebetween or a type of pigment dispersed with a pigment dispersant resin. At least either type of pigment is used. The pigment dispersant resin will be described later herein.

The pigment having surfaces to which anionic groups are bound directly or with another atomic group therebetween is, for example, such that a functional group containing an anionic group is bound to the surfaces of the pigment particles or such that an anionic resin is bound to the surfaces of the pigment particles. The pigment dispersed with a resin having an anionic functional group may also be used. Such pigment may be in a state where an anionic resin is physically adsorbed to the surfaces of the pigment particles or cover the pigment particles.

For the pigment containing an anionic group bound to the surfaces of the particles thereof, which is referred to as self-dispersible pigment, an anionic group, such as-COOM, —SO₃M, —PO₃HM, or —PO₃M₂, is bound to the surfaces of the pigment particles directly or with another atomic group therebetween. Examples of the species represented by M include hydrogen, lithium, sodium, potassium, ammonium (NH₄), and organic amines, such as methyl amine, ethyl amine, monoethanolamine, diethanolamine, and triethanolamine. Examples of the atomic group include linear or branched alkylene groups having a carbon number of 1 to 12, a phenylene group, a naphthylene group, an amide group, a sulfonyl group, an amino group, a carbonyl group, an ester group, an ether group, and combined groups of two or more of these groups.

Such a self-dispersible pigment may be produced by binding an anionic group to the surface of the pigment particles by a known oxidation process, or by binding a functional group containing an anionic group to the surfaces of the pigment particles by, for example, diazo coupling. The self-dispersible pigment may be such that an anionic resin is bound to the surfaces of the pigment particles. Such a self-dispersible pigment is prepared by binding a resin having an anionic group-containing unit as a hydrophilic unit to the surfaces of the pigment particles directly or with another atomic group therebetween.

In an embodiment, the ink jet ink composition may contain an inorganic pigment (white pigment) for printing on printing media such as transparent or translucent films. Such an ink jet ink composition can form an undercoat layer (referred to as a first layer later herein) tightly fixed with a high rub fastness that can sufficiently hide the background of the resulting printed item.

The pigments described above may be used in combination. The total content of the pigment (solids content) in the ink jet ink composition depends on the pigment used. In some embodiments, it may be 0.1% to 15.0% or 1.0% to 10.0% relative to the total mass (100%) of the ink composition from the viewpoint of achieving satisfactory color development. In the ink jet ink composition disclosed herein, the total content of the pigment is set so that the total mass of the pigment, the pigment dispersant resin, the polymer particles, and water can account for 95.0% or more of the total mass of the ink jet ink composition.

When the ink jet ink composition is prepared, the pigment may be dispersed in a medium in advance, and the pigment dispersion liquid thus prepared is added to the ink jet ink composition. For preparing the pigment dispersion liquid, a self-dispersible pigment may be dispersed in a dispersion medium without using a dispersant, or a polymer dispersant (pigment dispersant resin) may be used for dispersing a pigment in a dispersion medium. A surface-treated pigment may be dispersed in a dispersion medium.

### 1. 3. Pigment Dispersant Resin

The ink jet ink composition disclosed herein may contain a pigment dispersant resin to disperse the pigment. The pigment dispersant resin content is set so that the total mass of the pigment, the pigment dispersant resin, the polymer particles, and water can account for 95.0% or more of the total mass of the ink jet ink composition.

Resin-dispersed pigments in which an anionic resin is physically adsorbed to the surfaces of the pigment particles and resin dispersed pigments whose particles are covered with an anionic resin are dispersed with a pigment dispersant resin. The pigment dispersant resin is a copolymer containing a hydrophilic group and a hydrophobic group.

Any of the known resins that can be used in ink jet inks may be used as the pigment dispersant resin for the self-dispersible pigment or the resin-dispersed pigment. In some embodiments, the pigment dispersant resin may contain a hydrophilic group including an anionic group. The hydrophilic group may be that of a hydrophilic monomer, such as (meth)acrylic acid or a salt thereof. The hydrophobic group may be a functional group of a hydrophobic monomer, such as styrene or a derivative thereof, a monomer having an aromatic ring, such as benzyl (meth)acrylate, or a monomer having an aliphatic group, such as a (meth)acrylic acid ester.

The pigment dispersant resin may have a weight average molecular weight of 10,000 to 100,000 or 30,000 to 80,000 or have an acid value of 50 mg KOH/g to 150 mg KOH/g. In some embodiments, a styrene-(meth)acrylic resin or (meth)acrylic resin having an acid value of 50 mg KOH/g to 150 mg KOH/g may be used as the dispersant. If the pigment is dispersed with a dispersant, the mass ratio of the pigment dispersant resin to the pigment may be from 0.1 to 10.0 or from 0.5 to 5.0.

### 1. 4. Water

In some embodiments, the ink jet ink composition may be an aqueous ink containing water. Such an ink jet ink composition allows the polymer particles to disperse in the form of an emulsion, thus facilitating the formation of images tightly fixed with a high rub fastness by an ink jet method.

The water content in the ink jet ink composition is set so that the total mass of the pigment, the pigment dispersant resin, the polymer particles, and water can account for 95.0% or more of the total mass of the ink jet ink composition. The water content may be 85.0% or more or 88.0% or more relative to the total mass of the composition. In some embodiments, it may be 90.0% or more.

The water may be pure water or ultra-pure water from which ionic impurities have been removed as much as possible. Examples of such water include ion exchanged water, ultrafiltered water, reverse osmosis water, and distilled water. Sterile water prepared by, for example, UV irradiation or addition of hydrogen peroxide can prevent the occurrence of bacteria and Eumycota in the ink jet ink composition over a long time.

### 1. 5. Organic Solvent

The ink jet ink composition disclosed herein may contain an organic solvent. The organic solvent helps consistent ejection of the ink jet ink composition and reduces evaporation of water effectively from the ink composition staying in the printing head for a long time.

However, the content of the organic solvent, if used, is set so that the total mass of the pigment, the pigment dispersant resin, the polymer particles, and water can account for 95.0% or more of the total mass of the ink jet ink composition. Accordingly, the organic solvent content is at most less than 3% by mass.

The organic solvent may be soluble in water, and examples such an organic solvent include monohydric or polyhydric alcohols, (poly)alkylene glycols, glycol ethers, nitrogen-containing polar solvents, such as ε-caprolactam, 2-pyrrolidone, N-methylpyrrolidone, and other lactams, lactones, such as ε-caprolactone and δ-valerolactone, and sulfur-containing polar solvents, such as dimethyl sulfoxide (DMSO). In some embodiments, the organic solvent may be selected from among polyhydric alcohols and lactams, and, in an embodiment, 1,2-hexanediol or 2-pyrrolidone may be used.

Also, the organic solvent may be 1,2-hexanediol or propylene glycol, which helps the ink jet ink composition retain water, thus suppressing drying of the ink composition.

The total content of organic solvent in the ink jet ink composition may be 3.0% by mass or less relative to the total mass of the ink composition. In some embodiments, the total organic solvent content may be 0.5% by mass to 2% by mass.

If an organic solvent having a boiling point higher than 100.0° C. at 1.0 atmosphere is used, the organic solvent content may be less than 3.0% by mass. Since such an ink jet ink composition can dry more rapidly, the resulting printed item can be used immediately after printing.

### 1. 6. Surfactant

The ink jet ink composition disclosed herein may contain a surfactant. However, the content of the surfactant, if used, is set so that the total mass of the pigment, the pigment dispersant resin, the polymer particles, and water can account for 95.0% or more of the total mass of the ink jet ink composition.

The surfactant may be any of the nonionic surfactants, the anionic surfactants, the cationic surfactants, the amphoteric surfactants. Such surfactants may be used in combination. In some embodiments, a nonionic surfactant, such as an acetylene glycol-based surfactant or a silicone surfactant, may be used. Such surfactants are likely to spread over the printing medium and to dry rapidly. In addition, the ink composition tends to be consistently ejected.

The total content of surfactant, if contained in the ink jet ink composition, may be 0.01% to 3.0% or 0.05% to 2% relative to the total mass of the ink jet ink composition. In some embodiments, it may be, by mass, 0.1% to 1.0% or 0.2% to 0.5%.

The ink jet ink composition disclosed herein may contain a chelating agent. Chelating agents capture metal ions. Exemplary chelating agents include ethylenediaminetetraacetic acid (EDTA) salts, ethylenediamine nitrilotriacetates, hexametaphosphates, pyrophosphates, and metaphosphates.

### 1. 7. Preservative

The ink jet ink composition disclosed herein may contain a preservative. However, the content of preservative, if used, is set so that the total mass of the pigment, the pigment dispersant resin, the polymer particles, and water can account for 95.0% or more of the total mass of the ink jet ink composition.

The use of a preservative reduces the growth of mold and bacteria, and the ink composition can be stably stored. Therefore, the ink jet ink composition can be used as a maintenance liquid that may be used, for example, when a printer not used for a long time is maintained. In an embodiment, the preservative may be selected from among Proxel CRL, Proxel BDN, Proxel GXL, Proxel XL-2, Proxel IB, and Proxel TN.

### 1. 8. pH Adjuster

The ink jet ink composition disclosed herein may contain a pH adjuster. However, the content of pH adjustor, if used, is set so that the total mass of the pigment, the pigment dispersant resin, the polymer particles, and water can account for 95.0% or more of the total mass of the ink jet ink composition.

The pH adjuster in the ink jet ink composition suppresses the elution of impurities from a member or component of the ink flow channels and adjusts the degree of cleaning of the jet ink composition. Examples of the pH adjuster include morpholine compounds, piperazine compounds, and amino alcohols, such as triethanolamine.

### 1. 9. Other Constituents

The ink jet ink composition disclosed herein may further contain a water-soluble organic compound that is solid at room temperature, such as urea, ethyleneurea, or any other urea derivative, provided that the total mass of the pigment, the pigment dispersant resin, the polymer particles, and water accounts for 95.0% or more of the total mass of the ink jet ink composition. In addition, the ink jet ink composition may optionally contain other additives, such as a corrosion inhibitor, an antifungal agent, an antioxidant, an antireductant, an evaporation promoter, and a water-soluble resin.

### 1. 10. Preparation of Ink Jet Ink Composition

The ink jet ink composition may be prepared in any process without particular limitation and, for example, in the following process. A dispersion or solution of the polymer particles and the constituents of the ink composition are mixed in any order and, optionally, subjected to filtration to remove impurities. For mixing the constituents, for example, the constituents may be added one after another into a container equipped with a stirring device, such as a mechanical stirrer or a magnetic stirrer, and the contents of the container are stirred.

### 1. 11. Physical Properties of Ink Jet Ink Composition

Beneficially, the ink jet ink composition of the present disclosure has a surface tension at 20° C. of 20 mN/m to 40 mN/m or 20 mN/m to 35 mN/m from the viewpoint of the balance between the image quality and the reliability of the ink jet printing ink composition. The surface tension can be determined by measuring the ink composition wetting a platinum plate at 20° C. with, for example, an automatic surface tensiometer CBVP-Z (manufactured by Kyowa Interface Science).

Also, from the same viewpoint as above, the viscosity of the ink jet ink composition may be 1.0 mPa·s to 3.0 mPa·s, for example, 1.5 mPa·s to 2.5 mPa·s, at 20° C. The viscosity can be measured at 20° C. with, for example, a viscoelasticity meter MCR-300 (manufactured by Pysica).

### 2. Ink Jet Printing Method

The ink jet printing method disclosed herein performs printing on a printing medium with the above-described ink jet ink composition. An ink jet printing apparatus described below facilitates the printing by the ink jet printing method. The printing medium and the ink jet printing apparatus will now be described.

### 2. 1. Printing Medium

The printing medium used in the ink jet printing method disclosed herein may be, but is not limited to, an absorbent recording medium, a poorly absorbent or non-absorbent printing medium. The poorly absorbent or non-absorbent printing medium mentioned herein refers to a printing medium that hardly absorbs or does not absorb ink. More specifically, the poorly absorbent or non-absorbent printing medium exhibits a water absorption of 10 mL/m² or less for a period of 30 ms^{1/2} from the beginning of contact with water, measured by Bristow's method. The Bristow's method is most broadly used for measuring liquid absorption in a short time, and Japan Technical Association of the Pulp and Paper Industry (JAPAN TAPPI) officially adopts this method. Details of this method are specified in Standard No. (Paper and Paperboard—Liquid Absorption Test Method—Bristow's Method (in Japanese)) of JAPAN TAPPI Paper and Pulp Test Methods edited in 2000 (in Japanese). Such a non-absorbent printing medium may be a medium not provided with an ink-absorbent ink-receiving layer at the printing side thereof or a medium coated with a poorly ink-absorbent layer at the printing side thereof.

More specifically, the non-absorbent printing medium may be, but is not limited to, a plastic film not provided with an ink-absorbent layer, or a paper sheet or any other base material coated or bonded with a plastic film. The term plastic mentioned here may be polyvinyl chloride, polyethylene terephthalate, polycarbonate, polystyrene, polyurethane, polyethylene, or polypropylene.

The ink jet ink composition disclosed herein may be applicable to poorly absorbent printing media. The poorly absorbent printing medium may be, but is not limited to, coated paper including a coating layer at the surface thereof for receiving oil-based ink. The coated paper may be, but is not limited to, book-printing paper, such as art paper, coat paper, or matte paper.

The ink jet ink composition disclosed herein can be favorably applied onto such non-absorbent or poorly absorbent printing media to form an image or coating having high fixability and high rub fastness.

Also, the printing medium may be in the form of a bag or a sheet or any other form. The ink jet ink composition is useful to plastic film bags. In some embodiments of the ink jet printing method disclosed herein, the printing medium, onto which the ink jet ink composition is applied, may mainly contain polyolefin, such as polyolefin or polypropylene. Such a printing medium is generally difficult to bond but is beneficial for imparting high fixability and high rub fastness to the images formed thereon. In an embodiment, the printing medium may be surface-treated in advance with corona or plasma to reduce ink separation from the printing medium.

### 2. 2. Ink Jet Printing Apparatus

The ink jet ink composition disclosed herein may be used in an ink jet printing apparatus that will now be described. The following ink jet printing apparatus includes a printing head operable to eject the ink jet ink composition to apply the ink composition onto a printing medium. The printing head has a circulation path through which the ink jet ink composition is circulated.

### 2. 2. 1. Outline of Ink Jet Printing Apparatus

An embodiment of the ink jet printing apparatus disclosed herein will now be described with reference to the drawings. For easy recognition, the dimensional proportions of the members and components in the drawing are varied as needed.

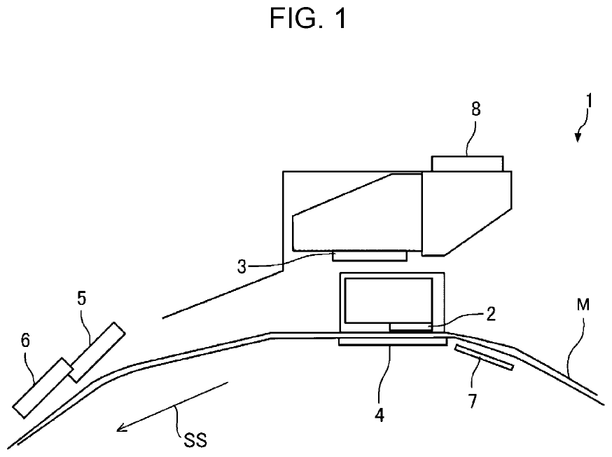

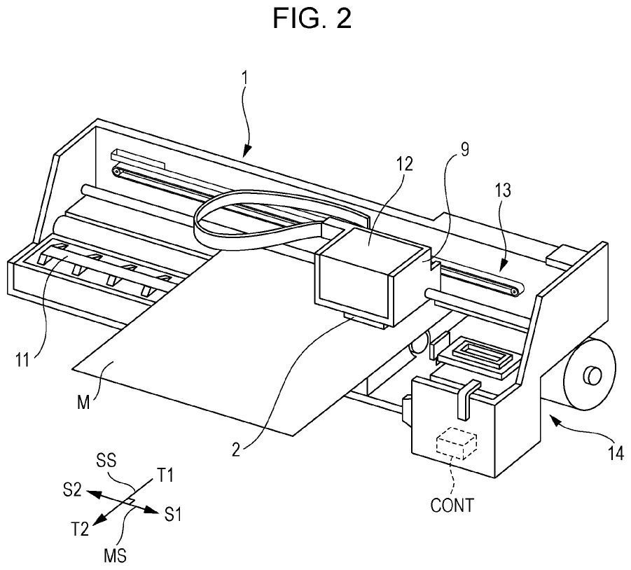

FIG. 1 is a schematic sectional view of an ink jet printing apparatus 1. FIG. 2 is a perspective view illustrating a configuration of the carriage and the vicinity thereof of the ink jet printing apparatus 1 shown in FIG. 1. As shown in FIGS. 1 and 2, the ink jet printing apparatus 1 includes a printing head 2, an IR heater 3, a platen heater 4, a secondary heater 5, a cooling fan 6, a preheater 7, a ventilation fan 8, a carriage 9, a platen 11, a carriage transfer mechanism 13, a transport device 14, and a control unit CONT. For use of the ink jet ink composition disclosed herein, only a platen heater 4 may be provided for heating. Such an ink jet printing apparatus is easy to downsize. The general operation of the ink jet printing apparatus 1 is controlled by the control unit CONT shown in FIG. 2.

The printing head 2 is configured to eject ink through nozzles thereof, thus applying the ink onto a printing medium M. In the present embodiment, the printing head 2 is of a serial type that applies ink onto the printing medium M while scanning the printing medium M in a scanning direction a plurality of times. The printing head 2 is mounted in the carriage 9 shown in FIG. 2. The printing head 2 scans the printing medium M in the scanning direction a plurality of times with the operation of the carriage transfer mechanism 13 that transfers the carriage 9 in the width direction of the printing medium M. The width direction of the printing medium is the scanning direction in which the printing head 2 scans the printing medium. A pass or movement of the printing head 2 in the scanning direction is referred to as a scan. The scanning direction and the sub-scanning direction may refer to one or both of the two directions toward one end and the other.

In the present embodiment, the scanning direction is a direction in which the carriage 9 equipped with the printing head 2 moves. In FIG. 1, the scanning direction intersects the sub-scanning direction indicated by arrow SS that is the direction in which the printing medium M is transported. In FIG. 2, the width direction of the printing medium M, that is, the S1-S2 directions, is the scanning directions MS, and the T1-T2 direction is the sub-scanning direction SS. When the printing head 2 scans the printing medium once, the printing head 2 moves in one of the directions indicated by arrows S1 and S2. By repeating such scanning operation of the printing head 2 and sub-scanning operation for transporting the printing medium M, an image is printed on the printing medium M. In other words, ink is applied by plural times of the scanning operation of the printing head 2 moving in the scanning direction and plural times of the sub-scanning operation of the printing medium M moving in the sub0-scanning direction intersecting the scanning direction.

The cartridge 12 operable to feed ink or the like to the printing head 2 includes a plurality of cartridges independent of each other. The cartridge 12 is removably mounted on the cartridge 9 equipped with the printing head 2. Each of the cartridges contains a different type of ink composition or the like, and the ink compositions or the like are fed to the nozzles from the respective cartridges 12. Although the present embodiment illustrates the cartridge 12 mounted on the carriage 9, a cartridge of an embodiment may be disposed at a position other than the carriage 9 so that the ink compositions or the like can be fed to the nozzles through a feed tube (not shown).

Ejection from the printing head 2 may be performed by a known technique. In the present embodiment, the printing head 2 ejects droplets by vibration of piezoelectric elements, that is, ejects droplets formed by mechanical deformation of electrostrictive elements.

The ink jet printing apparatus 1 includes the IR heater 3 and the platen heater 4 that are operable to heat the printing medium M when ink compositions are ejected from the printing head 2. For use of the ink jet ink composition disclosed herein, the IR heater 3 is optional, and only the platen heater 4 may be used from the viewpoint of downsizing the apparatus.

The IR heater 3, if used, heats the printing medium M by infrared radiation from the side on which the printing head 2 is located. The IR heater is likely to heat the printing head 2 simultaneously with the printing medium M, but can increase the temperature of the printing medium M without being affected by the thickness of the printing medium M, unlike the case of the platen heater 4 that heats the printing medium M from the rear side. A fan (for example, the ventilation fan 8) may be provided for applying warm air or a wind having the same temperature as the ambient temperature to the printing medium M to dry the ink or the like on the printing medium M.

The platen heater 4 can heat the printing medium M with the platen 11 therebetween, at a position opposite the printing head 2, to dry the ink composition ejected from the printing head 2 immediately after the ink composition or the like has been applied onto the printing medium M. The platen heater 4, which heats the printing medium M by conduction, is optional in the ink jet printing method disclosed herein. In an embodiment using the platen heater 4, the surface temperature of the printing medium M may be controlled to 40.0° C. or less.

The upper limit of the surface temperature of the printing medium M heated by the IR heater 3 and/or the platen heater 4 may be 60.0° C. or less, for example, 58.0° C. or less, 55.0° C. or less, or 53.0° C. or less. Also, the lower limit of the surface temperature of the printing medium M may be 30.0° C. or more, for example, 35.0° C. or more, 40.0° C. or more, or 42.0° C. or more. Thus, the ink compositions in the printing head 2 are unlikely to be dried or deteriorated, and the ink compositions or the resin therein are unlikely to adhere to the inner wall of the printing head 2. In addition, the ink composition on the printing medium M is rapidly dried and fixed, and, consequently, the resulting printed item can be immediately used.

The secondary heater 5, which is optional, is operable to dry or solidify the ink composition applied onto the printing medium M, that is, acts as an auxiliary heater or dryer. The secondary heater 5 is used for post-application heating. The secondary heater 5 heats the image printed on the printing medium M to rapidly evaporate water or any other solvent from the ink composition in the image, and, consequently, the resin remaining in the ink forms an ink coating film. Thus, the ink coating film is firmly fixed or adheres to the printing medium M, thus forming a high-quality image in a short time. The upper limit of the surface temperature of the printing medium M heated by the secondary heater 5 may be 120.0° C. or less, for example, 100.0° C. or less or 90.0° C. or less. Also, the lower limit of the surface temperature of the printing medium M at this time may be 60.0° C. or more, for example, 70.0° C. or more or 80.0° C. or more. By controlling the surface temperature of the printing medium in such a range, high-quality images can be formed in a short time.

The ink jet printing apparatus 1 may include a cooling fan 6. By cooling the ink composition applied onto the printing medium M with the cooling fan 6 after drying, the ink composition can form an ink coating film on the printing medium M with high adhesion.

The ink jet printing apparatus 1 may also include a preheater 7 operable to previously heat the printing medium M before ink compositions are applied onto the printing medium M. Furthermore, the ink jet printing apparatus 1 may include the ventilation fan 8 operable to efficiently dry the ink composition or the like on the printing medium M.

Below the carriage 9 are disposed a platen 11 on which the printing medium M is supported, a carriage transfer mechanism 13 operable to transfer the carriage 9 relative to the printing medium M, and a transport device 14 that is a roller operable to transport the printing medium M in the sub-scanning direction. The control unit CONT controls the operations of the carriage transfer mechanism 13 and the transport device 14.

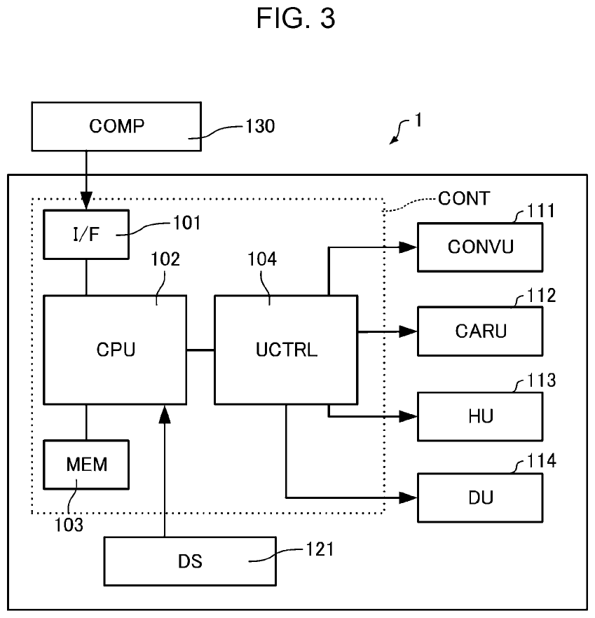

FIG. 3 is a functional block diagram of the ink jet printing apparatus 1. The control unit CONT is operable to control the recording apparatus 1. An interface (I/F) 101 enables data communication between the computer (COMP) 130 and the printing apparatus 1. A CPU 102 is an arithmetic processing unit configured to control the general operation of the printing apparatus 1. A memory device (MEM) 103 secures a storage in which the program of the CPU 102 is stored and a region in which the CPU 102 works. The CPU 102 causes a unit control circuit (UCTRL) 104 to control various units. Detectors (DS) 121 monitor the interior of the ink jet printing apparatus 1. The control unit CONT controls each unit according to the monitoring results of the detectors.

A transport unit (CONVU) 111 controls the sub-scanning operation of the ink jet printing apparatus, that is, the direction and the speed of the transport of the printing medium. More specifically, the transport direction and speed of the printing medium M are controlled by controlling the rotational direction and speed of the transport roller driven by a motor.

A carriage unit (CARU) 112, which is operable to control the scanning operation (passes) for ink jet printing, reciprocally moves the printing head 2 in the scanning direction. The carriage unit 112 includes the carriage 9 equipped with the printing head 2, and the carriage transfer mechanism 13 operable to reciprocally move the carriage 9.

A head unit (HU) 113 is operable to control the amount of the ink composition ejected through the nozzles of the printing head 2. For example, if piezoelectric elements drive the ejection through the nozzles of the printing head 2, the head unit 113 controls the operation of the piezoelectric elements for the nozzles. The head unit 113 controls the application timing, the dot size, and the like of ink compositions. In addition, a combination of controls by the carriage unit 112 and the head unit 113 controls the amount of ink compositions applied during one scanning operation. In addition, a combination of controls by the carriage unit 112 and the head unit 113 controls the operation for vibrating the ink composition or the like in the printing head 2 without ejecting the ink composition. This operation will be described later herein.

A drying unit (DU) 114 is operable to control the temperatures of heaters, such as the IR heater 3, the preheater 7, the platen heater 4, and the secondary heater 5.

The ink jet printing apparatus 1 alternately repeats the scanning operation of moving the carriage 9 equipped with the printing head 2 in the scanning direction and the operation of transporting the printing medium (sub-scanning operation). For each time of the scanning operation (pass), at this time, the control unit CONT controls the carriage unit 112 to move the printing head 2 in the scanning direction and also controls the head unit 113 to eject the ink composition through specific nozzle openings of the printing head 2, thus applying droplets of the ink composition onto the printing medium M. The control unit CONT also controls the transport unit 111 to transport the printing medium M in a predetermined degree of transport in the transporting direction.

In the ink jet printing apparatus 1, a printing region on which a plurality of droplets have been applied is gradually transported by alternately repeating the scanning operation (pass) and the sub-scanning operation (medium transport). Then, the droplets on the printing medium M are dried with an after-heater 5 to complete an image. The completed printed item may be then wound into a roll by a winding mechanism or transported by a flatbed mechanism.

In an embodiment of the ink jet printing method disclosed herein, only the platen heater 4 may be provided as heating mechanism, and the transfer speed of the printing medium M may be controlled to 1.0 m/min or less, for example, 0.8 m/min or less or 0.5 m/min or less, while the printing medium M is heated with the platen heater 4. Since the ink jet ink composition disclosed herein contain no or little organic solvent, such implementation brings printed items into a state that can be immediately used, as well as downsizing the apparatus. Thus, the ink jet printing method can satisfy demands for downsizing, small-lot printing, energy saving, quick response, or the like in personal or small-business use, different from large-scale industries.

If printing at a speed of 1.0 m/min or less is considered to be slow, the printing head may be provided with a circulation path (described later herein) to increase the viscosity of the ink composition for ejection improvement. In this instance, the printing speed can be increased because the temperature of the platen heater or post-application heating temperature can be increased for high-speed printing. In this instance, the printing speed may be 2.0 m/min or less.

### 2. 2. 2. Printing Head Having Circulation Path

The ink jet ink composition according to an embodiment of the present disclosure may be ejected from a printing head having a circulation path for the ink composition. In other words, at least the ink jet ink composition circulates in the circulation path. Also, the printing head may have a circulation path in which the ink jet ink composition circulates.

In the present embodiment, the printing head 2 has a circulation path in which the ink jet ink composition circulates. The circulation path enables the ink jet ink composition to flow back upstream to mix with a new portion of the ink jet ink composition, thus maintaining consistent ejection of the ink jet ink composition even if the ink jet ink composition dries or the solute content in the ink jet ink composition increases.

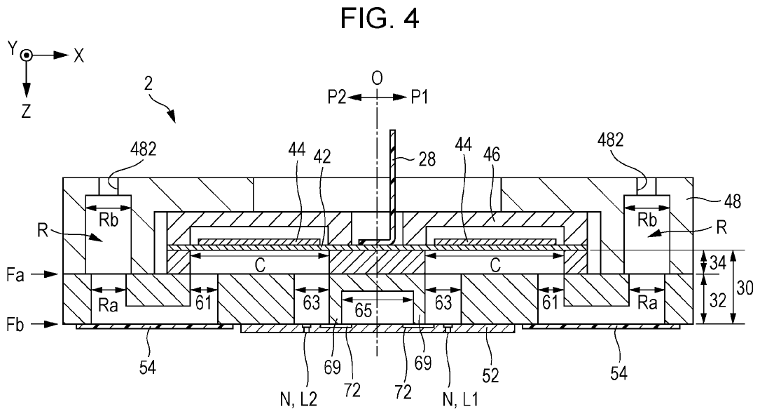

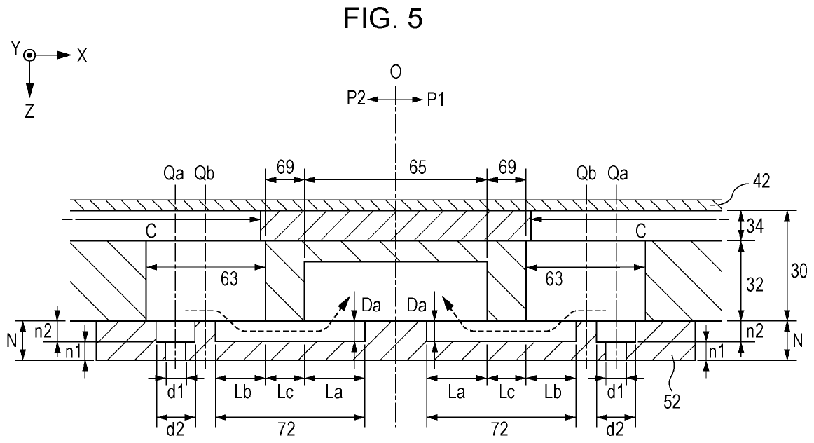

FIG. 4 is a schematic sectional view of the printing head 2 taken in a direction perpendicular to the Y direction in which the printing medium M is transported (the sub-scanning direction SS in FIG. 2), and FIG. 5 is schematic sectional view of the circulation chamber and the vicinity thereof in the printing head 2. In FIG. 4, the plane parallel to the surface of the printing medium is defined as the X-Y plane, and a direction perpendicular to the X-Y plane is defined as the Z direction. The direction in which the printing head 2 ejects the ink jet ink composition corresponds to the Z direction.

A plurality of nozzles N of the printing head 2 are aligned in the Y direction. In the following description, the plane that passes through the central axis parallel to the Y direction of the printing head 2 and that is parallel to the Z direction, that is, the Y-Z plane O, is referred to as the “central plane”.

As shown in FIG. 4, the printing head 2 has nozzles N in a first line L1 and nozzles N in a second line L2, and components or members associated with the nozzles N in the first line L1 and components or members associated with the nozzles N in the second line L2 are symmetrically arranged with respect to the central plane O. The portion of the printing head 2 on the positive side of the central plane O in the X-direction (hereinafter referred to as the first portion P1), and the portion on the negative side in the X direction (hereinafter referred to as the second portion P2) have substantially the same structure. The nozzles N in the first line L1 are formed in the first portion P1, and the nozzles N in the second line L2 are formed in the second portion P2. The central plane O is the boundary between the first portion P1 and the second portion P2.

In FIG. 4, the nozzles N in the second line L2 and the nozzles N in the first line L1 define nozzle lines to be filled with the ink jet ink composition. The region of the printing head through which the ink composition is ejected (nozzle lines to be filled with the ink composition), which is not described here, may have the same structure.

As shown in FIG. 4, printing head 2 has a flow path portion 30. The flow path portion 30 is a structure in which flow paths through which the ink jet ink composition is fed to the nozzles N are formed. In the present embodiment, the flow path portion 30 includes two layers: a first flow path substrate 32 and a second flow path substrate 34. The first flow path substrate 32 and the second flow path substrate 34 are each a plate member that is long in the Y direction. The second flow path substrate 34 is disposed with, for example, an adhesive on the surface Fa of the first flow path substrate 32 on the negative side in the Z direction.

As shown in FIG. 4, the first flow path substrate 32 is provided, at the surface Fa thereof, with a vibration member 42, piezoelectric elements 44, a protection member 46, and a housing 48, in addition to the second flow path substrate 34. On the positive side in the Z direction of the first flow path substrate 32, that is, on the surface Fb opposite the surface Fa, a nozzle plate 52 and an absorber 54 are disposed. The members or components of the printing head 2 are generally long in the Y direction as well as the first flow path substrate 32 and the second flow path substrate 34 and are bonded together with, for example, an adhesive. The Z direction may be considered to be the direction in which the first flow path substrate 32 and the second flow path substrate 34 are stacked, the direction in which the first flow path substrate 32 and the nozzle plate 52 are stacked, or the direction perpendicular to the surfaces of various plate members.

The nozzle plate 52 is a plate member having a plurality of nozzles N therein and is disposed on the surface Fb of the first flow path substrate 32 with, for example, an adhesive. Each of the nozzles is a circular through-hole through which the ink jet ink composition passes. The nozzle plate 52 of the disclosed embodiment has nozzles N defining the first line L1 and nozzles N defining the second line L2. More specifically, the nozzles N in the first line L1 are aligned in the Y direction on the positive side in the X direction of the nozzle plate 52 with respect to the central plane O, and the nozzles N in the second line L2 are aligned in the Y direction on the negative side in the X direction of the nozzle plate 52. The nozzle plate 52 is a continuous one-piece plate member having both the nozzles N in the first line L1 and the nozzles N in the second line L2. The nozzle plate 52 is formed of a monocrystalline silicon substrate by a semiconductor processing technology, such as dry etching or wet etching. The nozzle plate 52 may be formed by using any other known material and process.

As shown in FIG. 4, the first flow path substrate 32 has a space Ra, a plurality of feed paths 61, and a plurality of communication paths 63 in both the first portion P1 and the second portion P2. The space Ra is an opening having a rectangular shape long in the Y direction when viewed in the Z direction, and the feed paths 61 and the communication paths 63 are through-holes formed individually for the nozzles N. The communication paths 63 are aligned in the Y direction when viewed from above, and the feed paths 61 are aligned in the Y direction between the alignment of the communication paths 63 and the space Ra. The feed paths 61 communicate with and share the space Ra. Any one of the communication paths 63 is coincident in position with the corresponding nozzle N when viewed from above. More specifically, any one of the communication paths 63 in the first portion P1 communicates with the corresponding nozzle N in the first line L1. Similarly, any one of the communication paths 63 in the second portion P2 communicates with the corresponding nozzle N in the second line L2.

As shown in FIG. 4, the second flow path substrate 34 is a plate member having a plurality of pressure chambers C in each of the first portion P1 and the second portion P2. The pressure chambers C in each portion are aligned in the Y direction. The pressure chambers C are provided one for each nozzle N and are each a space long in the X direction when viewed from above. As with the nozzle plate 52, the first flow path substrate 32 and the second flow path substrate 34 are, for example, formed of a monocrystalline silicon substrate by a semiconductor processing technology. The first flow path substrate 32 and the second flow path substrate 34 may be formed by using any other known material and process. As described above, the flow path portion 30 and the nozzle plate 52 of the disclosed embodiment include a substrate made of silicon. Such a material can be processed into a flow path portion 30 and a nozzle plate 52 that have fine and precise flow paths by semiconductor processing.

As shown in FIG. 4, the second flow path substrate 34 is provided with a vibration member 42 on the surface thereof opposite the first flow path substrate 32. The vibration member 42 disclosed herein is an elastic plate capable of vibrating. In an embodiment, the second flow path substrate 34 and the vibration member 42 may be formed in a one-piece body whose thickness is selectively reduced corresponding to the positions of the pressure chambers C.

The surface Fa of the first flow path substrate 32 and the vibration member 42 oppose each other with the spaces of the pressure chambers C therebetween, as shown in FIG. 4. The pressure chambers C, which are spaces formed between the surface Fa of the first flow path substrate 32 and the vibration member 42, cause the ink jet ink composition in the spaces to vary in pressure. The pressure chambers C are each a space that is, for example, long in the X direction and are formed individually, one for each nozzle N. The pressure chambers C are arranged in the Y direction for each of the first line L1 and the second line L2.

As shown in FIG. 4, one end adjacent to the central plane O of any one of the pressure chambers C is aligned with the corresponding communication path 63 when viewed from above, and the other end, opposite the central plane O, is aligned with the corresponding feed path 61 when viewed from above. Thus, the pressure chambers C communicate with the nozzles N through the communication paths 63 and communicate with the space Ra through the feed paths 61 in each of the first portion P1 and the second portion P2. In an embodiment, partially narrowed flow paths may be formed in the pressure chambers C to give the ink composition a predetermined flow resistance.

A plurality of piezoelectric elements 44 are provided on the surface of the vibration member 42 opposite the pressure chambers individually for the nozzles N in each of the first portion P1 and the second portion P2, as shown in FIG. 4. The piezoelectric elements 44 are elements that deform with driving signals applied thereto. The piezoelectric elements 44 are arranged in the Y direction, corresponding to the pressure chambers C. Any one of the piezoelectric elements 44 is a multilayer composite that, for example, includes two electrodes with a piezoelectric layer therebetween. Alternatively, the portions that deform with driving signals applied thereto, that is, active portions that vibrate the vibration member 42, may define piezoelectric elements 44. In the disclosed embodiment, when the vibration member 42 vibrates in conjunction with the deformation of the piezoelectric elements 44, the pressure in the pressure chambers C varies, and thus, the ink jet ink composition in the pressure chambers C is ejected through the communication paths 63 and the nozzles N.

The protection member 46 shown in FIG. 4 is a plate member configured to protect the plurality of piezoelectric elements 44 and is disposed on the surface of the vibration member 42 or the surface of the second flow path substrate 34. The protection member 46 may be formed of any material by any method but may be formed in the same manner as in the case of the first flow path substrate 32 and the second flow path substrate 34, for example, by semiconductor processing of a monocrystalline silicon substrate. The piezoelectric elements 44 arranged in the Y direction are accommodated individually in the recesses formed in the surface, adjacent to the vibration member 42, of the protection member 46.

A terminal of a wiring board 28 is coupled to the surface, opposite the flow path portion 30, of the vibration member 42 or the surface of the flow path portion 30. The wiring board 28 is a flexible component having a plurality of conducting wires (not shown) that electrically couple the control unit to the printing head 2. A terminal of the wiring board 28 is extracted through an opening of the protection member 46 and an opening of the housing 48 and coupled to the control unit 20. A flexible wiring board, such as a flexible printed circuit (FPC) or a flexible flat cable (FFC) may be used as the wiring board 28.

The housing 48 is a case adapted to hold the ink jet ink composition to be fed to the pressure chambers C and further to the nozzles N. The surface of the housing 48 on the positive side in the Z direction is bonded to the surface Fa of the first flow path substrate 32 with, for example, an adhesive. The housing 48 may be formed by using any known material and process. For example, the housing 48 may be formed by injection molding of a resin material.

As shown in FIG. 4, the housing 48 has a space Rb in each of the first portion P1 and the second portion P2. The space Rb of the housing 48 and the space Ra of the first flow path substrate 32 communicate with each other. The space Ra and the space Rb define a space that acts as a liquid reservoir R from which the ink jet ink composition is fed to the pressure chambers C. The liquid reservoir R is a common ink chamber shared with the plurality of nozzles N. Each of the first portion P1 and the second portion has the liquid reservoir R. The liquid reservoir R in the first portion P1 is located on the positive side in the X-direction with respect to the central plane O, and the liquid reservoir R in the second portion P2 is located on the negative side in the X direction with respect to the central plane O. The housing 48 has inlets 482 in the surface thereof opposite the first flow path substrate 32. The ink fed from a liquid container 14 is introduced into the liquid reservoirs R through the respective inlets 482.

As shown in FIG. 4, a vibration absorber 54 is disposed on the surface Fb of the first flow path substrate 32 in each of the first portion P1 and the second portion P2. The vibration absorber 54 is a flexible film that absorbs pressure changes on the ink jet ink composition in the liquid reservoir R, thus being a compliance substrate. The vibration absorber 54 may be disposed, for example, on the surface Fb of the first flow path substrate 32 to close the space Ra and feed paths 61 of the first flow path substrate 32, thus defining a wall, more specifically, the bottom, of the reservoir.

As shown in FIG. 4, the first flow path substrate 32 has a space (hereinafter referred to as a liquid circulation chamber) 65 in the surface Fb thereof opposing the nozzle plate 52. The liquid circulation chamber 65 of the disclosed embodiment is an opening with a bottom that is long in the Y direction when viewed from above. The open end of the liquid circulation chamber 65 is closed by the nozzle plate 52 joined to the surface Fb of the first flow path substrate 32. The liquid circulation chamber 65 extends, for example, along the first line L1 and the second line L2 of the nozzles N. More specifically, the liquid circulation chamber 65 is formed between the alignment of the nozzles N in the first line L1 and the alignment of the nozzles N in the second line L2. Thus, the liquid circulation chamber 65 lies between the communication paths 63 in the first portion P1 and the communication paths 63 in the second portion P2. Thus, the flow path portion 30 is a structure having pressure chambers C and communication paths 63 in the first portion P1, pressure chambers and communication paths 63 in the second portion P2, and the liquid circulation chamber 65 between the arrangement of the communication paths 63 in the first portion P1 and the arrangement of the communication paths 63 in the second portion P2. The flow path portion 30 has a wall (hereinafter referred to as a partition) 69 to separate the liquid circulation chamber 65 from the communication paths 63, as shown in FIG. 4.

In each of the first portion P1 and the second portion P2, a plurality of piezoelectric elements 44, as well as the pressure chambers C, are arranged in the Y direction. Thus, the liquid circulation chamber 65 extends continuously in the Y direction along the arrangement of the pressure chambers C or the piezoelectric elements 44 in each of the first portion P1 and the second portion P2. In other words, the liquid circulation chamber 65 and the arrangement of the liquid reservoirs R extend in the Y direction apart at a distance, and the pressure chambers C, the communication paths 63, and the nozzles N are located within the distance, as shown in FIG. 4.

FIG. 5 is a fragmentary sectional view of the printing head 2, illustrating the liquid circulation chamber 65 and the vicinity thereof enlarged. As shown in FIG. 5, the individual nozzles N have a first zone n1 and a second zone n2. The first zone n1 and the second zone n2 are coaxial cylindrical spaces communicating with each other. The second zone n2 is closer than the first zone n1 to the flow path portion 30. In the disclosed embodiment, the central axis Qa of each nozzle N is opposite to the liquid circulation chamber 65 with respect to the central axis Qb of the communication path 63. The inner diameter d2 of the second zone n2 is larger than the inner diameter d1 of the first zone n1. Such nozzles in a step form are advantageous for controlling the flow resistance in each nozzle N as desired.

As shown in FIG. 5, the nozzle plate 52 is provided in each of the first portion P1 and the second portion P2 with a plurality of discharge paths 72 in the surface thereof opposing the flow path portion 30. The discharge paths 72 in the first portion P1 correspond one-to-one to the nozzles N in the first line L1 or the communication paths 63 corresponding to the first line L1. Similarly, the discharge paths 72 in the second portion P2 correspond one-to-one to the nozzles N in the second line L1 or the communication paths 63 corresponding to the second line L2.

Each discharge path 72 is a ditch, or opening with a bottom, that is long in the X direction, functioning as a path through which the ink jet ink composition flows. In the disclosed embodiment, the discharge path 72 has a distance from the corresponding nozzle N and is closer than this nozzle N to the liquid circulation chamber 65. The discharge path 72 is formed by, for example, a process using semiconductor technology, such as dry etching or wet etching, together with the nozzles N, particularly the second zone n2, in the same process at one time.

The discharge path 72 is linear and has a width equal to the inner diameter d2 of the second zone n2 of the nozzle N. The width, in the Y direction, of the discharge path 72 is smaller than the width, in the Y direction, of the pressure chamber C. Such a structure increases the flow resistance in the discharge path 72 compared to the structure in which the width of the discharge path 72 is larger than the width of the pressure chamber C. However, the discharge path 72 may be formed with a larger width than the pressure chamber C. The depth Da of the discharge path 72 from the surface of the nozzle plate 52 is constant throughout the length of the discharge path. In this instance, the discharge path 72 has a depth equal to the depth of the second zone n2 of the nozzle N. In an embodiment, the discharge path 72 and the second zone n2 may have different depths. It is however easier to form the discharge path 72 and the second zone n2 to the same depth. The depth of a flow path refers to the measurement in the Z direction of the flow path, that is, the difference in level between the open end and the bottom of the flow path.

Any one of the discharge paths 72 in the first portion P1 lies closer than the corresponding nozzle N to the liquid circulation chamber 65. Similarly, any one of the discharge paths 72 in the second portion P2 lies closer than the corresponding nozzle N to the liquid circulation chamber 65. The end, opposite the central plane O, of each discharge path 72 lies within the corresponding communication path 63 when viewed from above. Hence, the discharge path 72 communicates with the communication path 63. On the other side, the end adjacent to the central plane O of the discharge path 72 lies within the liquid circulation chamber 65 when viewed from above. Hence, the discharge path 72 communicates with the liquid circulation chamber 65. As described above, each of the communication paths 63 communicates with the liquid circulation chamber 65 through the discharge path 72. Thus, the ink jet ink composition in each communication path 63 is fed to the liquid circulation chamber 65 through the discharge path 72, as indicated by the broken lines with an arrowhead in FIG. 5. In other words, in the disclosed embodiment, the communication paths 63 corresponding to the nozzles N in the first line L1 and the communication paths 63 corresponding to the nozzles N in the second line L2 share and communicate with the single liquid circulation chamber 65.

In FIG. 5, any one of the discharge paths 72 has a portion with a length La overlapping with the liquid circulation chamber 65, a portion with a length Lb in the X direction overlapping with the communication path 63, and a portion with a length Lc in the X direction overlapping with the partition 69 of the flow path portion 30. Length Lc is equivalent to the thickness of the partition 69. The partition 69 acts as a stop of the discharge path 72. Accordingly, the longer the length Lc corresponding to the thickness of the partition 69, the larger the flow resistance in the discharge path 72. Although the relationship between length La and length Lc can be set as desired, length La, in the disclosed embodiment, is larger than length Lb and length Lc. In the disclosed embodiment, furthermore, length Lb is larger than length Lc. In such a structure, the ink jet ink composition can be easily introduced into the liquid circulation chamber 65 from the communication path 63 through the discharge path 72 compared to the structure in which length La and length Lb are shorter than length Lc.

In the printing head 2, the pressure chamber C communicates indirectly with the liquid circulation chamber 65 through the communication paths 63 and the discharge paths 72, as described above. Hence, the pressure chamber C does not communicate directly with the liquid circulation chamber 65. In such a structure, as the piezoelectric element 44 operates to change the pressure in the pressure chamber C, part of the ink jet ink composition flowing in the communication path 63 is ejected through the nozzle N, and part of the rest of the ink composition flows into the liquid circulation chamber 65 from the communication path 63 through the discharge path 72. The inertances in the communication path 63, the nozzle N, and the discharge path 72 are determined so that the amount (ejection amount) of the ink jet ink composition ejected from the communication path 63 through the nozzle N by one operation of the piezoelectric element 44 is larger than the amount (circulation amount) of the ink jet ink composition flowing into the ink circulation chamber 65 from the communication path 63 through the discharge path 72. In other words, if all the piezoelectric elements 44 are operated at one time, the total circulation amount of the ink composition flowing into the liquid circulation chamber 65 from the plural communication paths 63, for example, the amount per unit time of the ink composition flowing in the liquid circulation chamber 65, is larger than the total ejection amount of the ink composition ejected through the plural nozzles N.

More specifically, the flow resistance in each of the communication path 63, the nozzle N, and the discharge path 72 is determined so that the amount of the ink jet ink composition to be circulated can account for 70% or more (or the amount of the ink jet ink composition to be ejected can account for 30% or less) of the amount of the ink jet ink composition flowing in the communication path 63. Thus, the ink jet ink composition in the vicinity of the nozzles is circulated effectively through the liquid circulation chamber 65 with a sufficient ejection amount ensured. Broadly speaking, as the flow resistance in the discharge path 72 is increased, the circulation amount decreases, whereas the ejection amount increases; and as the flow resistance in the discharge path 72 is reduced, the circulation amount increases, whereas the ejection amount decreases.

In an embodiment, for example, the ink jet printing apparatus 1 may include a circulation mechanism (not shown). The circulation mechanism is configured to feed the ink jet ink composition in the liquid circulation chamber 65 to the liquid reservoirs R, that is, configured to circulate the ink composition. The circulation mechanism includes a suction mechanism, such as a pump, that sucks the ink jet ink composition from the liquid circulation chamber 65, a filter mechanism (not shown) operable to remove air bubbles and foreign matter from the ink jet ink composition, and a heating mechanism operable to heat the ink jet ink composition to reduce the viscosity of the ink composition. After air bubbles and foreign matter have been removed and the viscosity of the ink jet ink composition is reduced, the ink jet ink composition is fed to the liquid reservoirs R from the circulation mechanism through the respective inlets 482. Thus, the ink jet ink composition is circulated in the following order: the liquid reservoirs R, the feed paths 61, the pressure chambers C, the communication paths 63, the discharge paths 72, the liquid circulation chamber 65, the circulation mechanism, and the liquid reservoirs R.

The feed path 61 and the ejection path 72 correspond to the circulation path through which the ink jet ink composition in the corresponding pressure chamber C circulates. Thus, the ink jet ink composition fed into the pressure chambers C through the respective feed paths 61 discharges through the discharge paths 72 and enters the pressure chambers C again through the feed paths 61 without being ejected through nozzles.

The discharge paths 72 that formed in the nozzle plate 52 to connect the communication paths 63 to the liquid circulation chamber 65 enable the ink jet ink composition in the vicinity of the nozzles N to efficiently enter the liquid circulation chamber 65 for circulation. Also, in the disclosed embodiment, the communication paths 63 corresponding to the nozzles in the first line L1 and the communication paths 63 corresponding to the nozzles in the second line L2 communicate with and share the liquid circulation chamber 65 disposed therebetween. In such a structure, the printing head 2 can be simplified in structure and thus downsized compared to a structure in which a liquid circulation chamber communicating with the discharge paths 72 corresponding to the nozzles in the first line L1 and a liquid circulation chamber communicating with the discharge paths 72 corresponding to the nozzles in the second line L2 are individually provided.

In an embodiment, the discharge paths 72 and the corresponding nozzles N may be connected to each other without a gap. In an embodiment, additional liquid circulation chambers, other than the liquid circulation chamber 65, may be provided for each of the first portion P1 and the second portion P2.

The amount of ink jet ink composition flowing in the circulation paths may be controlled to a proportion in the range of 0.05 to 20.0, 0.1 to 10.0, 0.3 to 5.0, or 0.5 to 2.0 relative to the maximum amount of ink jet ink composition ejected onto the printing medium from the printing head. Such a proportion of the circulation amount to the ejection amount of the ink jet ink composition is in balance, and, in such a proportion, the ink composition can be sufficiently applied onto the printing medium while efficiently resisting drying or thickening.

The printing head having circulation paths described above can maintain reliable ejection of the ink jet ink composition even if the solute content in the ink jet ink composition is increased by drying. In other words, the ink jet printing apparatus including a printing head having circulation paths through which the ink jet ink composition in the pressure chambers is circulated enables consistent ejection of the ink jet ink composition disclosed herein.

In the printing head 2 including pressure chambers operable to apply a pressure to the ink jet ink composition to eject the ink composition through the corresponding nozzles, the circulation paths may be configured to return the ink jet ink composition discharged from the pressure chambers C to those pressure chambers. Furthermore, the circulation paths may be configured, for circulation of the ink jet ink composition, to discharge the ink jet ink composition from the printing head 2 and return the discharged ink jet ink composition to the printing head.

The printing head 2 of the disclosed embodiment is of a serial head. In an embodiment, however, the printing head 2 may be a line head. The line head, as well the serial head, can maintain reliable ejection of the ink jet ink composition by circulating the ink jet ink composition to reduce drying and thickening.

### 2. 2. 3. Implementation of Applying Micro-Vibration to Ink Jet Ink Composition

The ejection consistency of the ink jet ink composition disclosed herein may be increased by applying in-printing micro-vibration or out-of-printing micro-vibration to the ink jet ink composition in the pressure chambers of the printing head. As described above, the ink jet ink composition disclosed herein contains a moisturizing organic solvent with a low content. The volatile component (mainly water) of such an ink jet ink composition is likely to evaporate around the outlets of the nozzles, and thus, the ink jet ink composition tends to be thickened. Accordingly, micro-vibration may be applied to the ink composition to move meniscuses in the nozzles and diffuse the ink composition, thus suppressing thickening or viscosity increase.

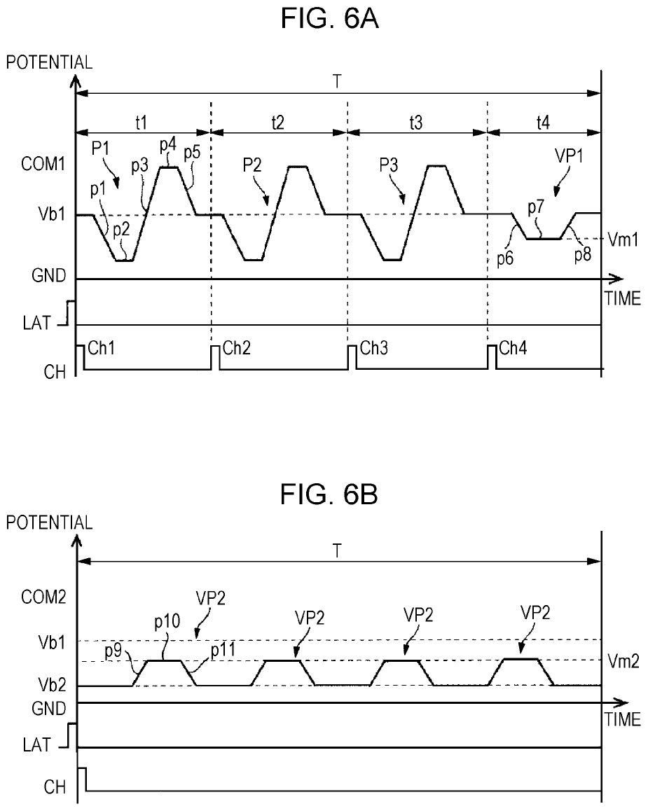

FIGS. 6A and 6B are waveform diagrams illustrating exemplary driving signals generated from a head unit 113: FIG. 6A illustrates a first driving signal COM 1 representing in-printing micro-vibration; and FIG. 6B illustrates a second driving signal COM 2 representing out-of-printing micro-vibration. In the illustrations, a unit period T is a cycle period of the driving signal COM 1 or COM 2. When a printing head 2 ejects an ink while moving relative to a printing medium M, the unit period corresponds to the period of time for which a nozzle moves a distance equivalent to the width of a pixel that is a constitutional unit of an image. The driving signals COM 1 and COM 2 are generated according to a latch signal LAT that is a timing signal generated based on an encoder pulse according to the scanning position of the printing head 2. The driving signals COM 1 and COM 2 are therefore generated in a cycle defined by latch signals LAT.

In the present embodiment, the ink jet printing apparatus 1 can form dots having varying sizes on the printing medium M for multi-tone printing and is configured to eject large dots, middle-sized dots, small dots, and no dots (micro-vibration), thus performing four-tone printing. In the present embodiment, the first driving signal COM 1 includes a first ejection driving pulse P1, a second ejection driving pulse P2, a third ejection driving pulse P3, and a first vibration driving pulse VP1 (corresponding to vibration driving pulse in an ejection period) that are generated in this order within a unit period T. The second driving signal COM 2 includes at least one second vibration driving pulse VP2 (corresponding to a driving pulse or a vibration driving pulse). While the printing head 2 is moving over the printing region of the printing medium M during printing (printing job) executed by the control unit CONT that has received printing data and a printing command (during the period in which the printing head 2 ejects ink through a nozzle for printing, hereinafter referred to as a printing period for the sake of convenience), any one of the driving pulses of the driving signal COM 1 is selectively applied to the piezoelectric element 44 in the pressure chamber C corresponding to the nozzle. On the other hand, while the printing head 2 during printing is accelerating or deaccelerating outside the printing region of the printing medium M or when the printing head 2 stops moving (during the period of no printing operation in which the printing head 2 does not eject ink through nozzles, hereinafter referred to as a pause period for the sake of convenience), the second driving signal COM 2 is applied to all the piezoelectric elements 44. Hence, in the present embodiment, an operation for what is called out-of-printing micro-vibration is performed outside the printing region during the pause period. The printing region mentioned herein refers to a region of the printing medium M in which an image, letters, symbols, or characters are printed by arranging ink dots (forming a dot pattern) on the printing medium M. The printing region, therefore, varies depending on the matter to be printed (what image or text is printed).

The ejection driving pulses P1 to P3 of the first driving signal COM 1 have a waveform set so as to eject ink through nozzles. More specifically, the ejection driving pulses P1 to P3 individually consist of an expansion component p1 to expand a pressure chamber C from a standard capacity that is corresponding to a first standard potential Vb1, an expansion-maintaining component p2 to maintain the expanded state for a specific period, a contraction component p3 to rapidly contract the pressure chamber C so as to eject ink through the corresponding nozzle, a contraction-maintaining component p4 to maintain the contracted state for a specific period, and a re-expansion component p5 to return the pressure chamber to the standard capacity from the contracted capacity. In contrast, the first vibration driving pulse VP1 has a waveform capable of vibrating a meniscus to the extent that ink is not ejected through the nozzle so as to suppress thickening of the ink at the nozzle of the printing head 2 during printing in the printing region. More specifically, the first vibration driving pulse VP1 consists of a vibration expansion component p6 to slightly expand the pressure chamber C to a vibration expansion capacity from the standard capacity that is corresponding to a first standard potential Vb1, a vibration expansion-maintaining component p7 to maintain the vibration expansion capacity for a specific period, and a first vibration contraction component p8 to return the pressure chamber to the standard capacity from the vibration expansion capacity.

The potentials of all the pulses of the first driving signal COM 1 start varying at the first standard potential Vb1. Hence, the start potential or end potential of each driving pulse is the first standard potential Vb1. The first standard potential Vb1 is adequately higher than the ground potential GND, as shown in FIG. 6A. The first vibration expansion component p6 of the first vibration driving pulse VP1 is a waveform component defined by potential decreasing from the first standard potential Vb1 to a vibration expansion potential Vm1 lower than the first standard potential Vb1. The vibration expansion-maintaining component p7 is a waveform component defined by the vibration expansion potential Vm1 maintained for a specific period, and the first vibration contraction component p8 is a waveform component defined by potential increasing from the vibration expansion potential Vm1 to the first standard potential Vb1. Thus, the first vibration driving pulse VP1 has a waveform protruding downward (toward the ground potential GND). However, in an embodiment, the first vibration driving pulse VP1 may have a waveform protruding upward (toward the high potential side, opposite the ground potential GND with respect to the first standard potential Vb1).

In the present embodiment, the size of dots formed on the printing medium M varies according to the number of selected ejection driving pulses in the driving signal COM. When dots are not formed on the printing medium M in the unit period T, that is, when printing is not performed due to no ejection through nozzles, the first vibration driving pulse VP1 is applied to the piezoelectric elements 44 corresponding to those nozzles. On applying the first vibration driving pulse VP1 to the piezoelectric elements 44, the ink in the corresponding pressure chambers C undergoes a relatively small change in pressure. This pressure change causes the meniscuses exposed at the nozzles to vibrate (micro-vibration). The micro-vibration of the meniscuses diffuses the thickened ink at the nozzles, thus suppressing thickening of the meniscuses. For forming a small dot on the printing medium in the unit period T, for example, the second ejection driving pulse P2 is selected and applied to a piezoelectric element 44. Thus, a droplet of ink is ejected through the corresponding nozzle to form a small dot on the printing medium M. For forming a middle-sized dot on the printing medium M in the unit period T, the first ejection driving pulse P1 and the third ejection driving pulse P3 are selected and successively applied to a piezoelectric element 44. Thus, two droplets of ink are continuously ejected through the corresponding nozzle. These droplets land on a predetermined pixel region of the printing medium M to form a middle-sized dot. For forming a large dot on the printing medium M in the unit period T, the first ejection driving pulse P1, the second ejection driving pulse P2, and the third ejection driving pulse P3 are selected and successively applied to a piezoelectric element 44. Thus, three droplets of ink are continuously ejected through the corresponding nozzle and land on a predetermined pixel region of the printing medium M to form a large dot. The size of dots is a relative measure. The dot size and the amount of actual liquid may be determined according to the specifications of the ink jet printing apparatus 1.

The second vibration driving pulse VP2 of the second driving signal COM 2 has a waveform capable of vibrating the meniscus at a nozzle to the extent that ink is not ejected through the nozzle so as to suppress thickening of the ink at the nozzle during the pause period in the printing operation in which the printing head 2 lies outside the printing region. More specifically, the second vibration driving pulse VP2 consists of a second vibration contraction component p9 (a first waveform component) to contract the pressure chamber C to a vibration contraction capacity from the standard capacity that is corresponding to a second standard potential Vb2, a vibration contraction-maintaining component p10 to maintain the vibration contraction capacity for a specific period, and a second vibration expansion component p11 (a second waveform component) to return the pressure chamber to the standard capacity from the vibration contraction capacity. In the present embodiment, 4 second vibration driving pulses VP2 in total are generated in the second driving signal COM 2 during a period corresponding to the unit period T, and the potential of any of the four starts varying at the second standard potential Vb2. Hence, the start potential or end potential of the second vibration driving pulses in the second driving signal COM 2 is the second standard potential Vb2. The second standard potential Vb2 is as much lower than the first standard potential Vb1 as possible, as shown in FIG. 6B. Specifically, the second standard potential Vb2 is a minimum in a possible range according to the specifications and design of the head unit 113 and is, more specifically, set to 2.5 V. The second vibration contraction component p9 of the second vibration driving pulse VP2 is a waveform component defined by potential increasing from the second standard potential Vb2 to a vibration contraction potential Vm2 higher than the second standard potential Vb2. The vibration contraction-maintaining component p10 is a waveform component defined by the vibration contraction potential Vm2 maintained for a specific period, and the second vibration expansion component p11 is a waveform component defined by potential decreasing from the vibration contraction potential Vm2 to the second standard potential Vb2. Thus, the second vibration driving pulse VP2 has a waveform protruding upward (toward the high potential side, opposite the ground potential GND with respect to the second standard potential Vb2).

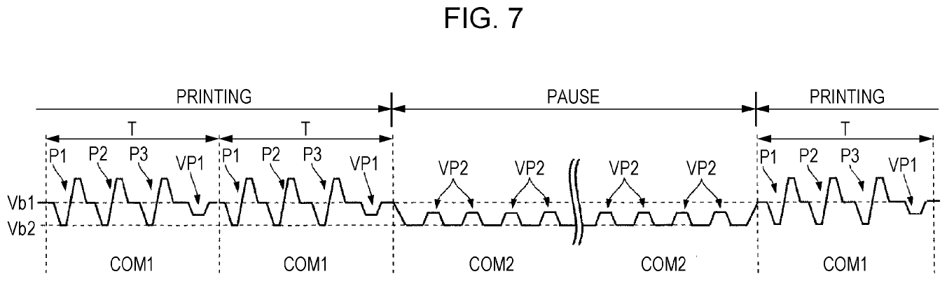

FIG. 7 is a timing chart of driving signal generation for printing of the ink jet printing apparatus 1. As shown in FIG. 7, the first driving signal COM 1 is generated from the head unit 113 every generation of a latch signal LAT in response to the movement of the printing head (in a cycle of the unit period T) during a printing period, in which the printing head 2 is moving over the printing region of the printing medium M during printing (printing job) executed by the control unit CONT that has received printing data and a printing command. Then, at least one of the driving pulses of the first driving signal COM 1 is applied to the piezoelectric element 44 according to tone information of dot pattern data, and thus, ink is ejected onto the printing medium M, or nozzles not to eject ink are vibrated. On the other hand, during a pause period, in which the printing head 2 during printing (printing job) is accelerating or deaccelerating outside the printing region of the printing medium or stops moving, the second driving signal COM 2 is generated from the head unit 113. Then, second vibration driving pulses VP2 of the second driving signal COM2 are individually applied to all the piezoelectric elements 44 of the printing head 2 for vibrating operation. Thus, thickening of the ink in the printing head is suppressed during the pause period.

Since the second standard potential Vb2 of the second driving signal COM 2 generated in the pause period is as much lower than the first standard potential Vb1 of the first driving signal COM 1 generated in the printing period as possible, the general potential (driving voltage) of the second driving signal COM2 decreases, and power consumption in the pause period decreases accordingly. Thus, power consumption of the ink jet printing apparatus 1 can be further reduced. In the present embodiment, since the second vibration driving pulse VP2 has a waveform protruding upward, the second standard potential Vb2 can be a minimum in a possible range according to the specifications and design of the head unit 113. Thus, power consumption can be further reduced. Also, since a second standard potential Vb2 that is not 0 at least during the pause period is applied to the piezoelectric elements 44, the time lag until the printing head comes into a state capable of ejecting ink after the printing head moves the printing region from a position outside the printing region can be reduced compared to the case where a driving signal is not applied (where applied potential is 0), and smooth transition is made from a pause state to a printing operation.

The implementation of the subject matter disclosed herein is not limited to the above-described embodiments, and various modifications may be made. For example, the number, the type, and the like of the driving pulses in the first driving signal COM1 are not limited to those disclosed above, and any know driving pulses may be used, and any number of driving pulses may be generated provided that it is one or more. Similarly, the number of second vibration driving pulses V P2 in the second driving signal COM 2 may be three or more or five or more, without being limited four as in the disclosed embodiment. In an embodiment, the second driving signal COM 2 may not include second vibration pulses VP2. In this instance, only the second standard potential Vb2 is successively applied to the piezoelectric elements 44 in the pause period. In some embodiments, the waveform of the second vibration driving pulse VP2 protrudes upward from the viewpoint of minimizing the second standard potential Vb2.

In an embodiment, a third driving signal COM 3, different from the first driving signal COM 1 and the second driving signal COM 2, may be generated in the pause period in which the printing head 2 is deaccelerating until the movement of the head 2 stops or is accelerating until the head 2 in a stational state starts moving and reaches the printing region, and a third standard potential Vb3 that is the standard potential of the third driving signal COM 3 is set between the first standard potential Vb1 and the second standard potential Vb2. Thus, the potential may vary step by step between the first standard potential Vb1 and the second standard potential Vb2. The third standard potential Vb3 may be set to a value at which the electric field of the piezoelectric elements 44 in terms of piezoelectric hysteresis comes to zero, and the second standard potential Vb2 lower than such a third standard potential Vb3 may be set so that if the third standard potential Vb3 is applied to a piezoelectric element 44 for a long time, the polarization of the piezoelectric element 44 can be changed. In this instance, the third driving signal COM 3 may be applied to the piezoelectric element 44 in a stand-by state before staring printing (and in a state where the stand-by state continues relatively long), and the second driving signal COM 2 may be applied to the piezoelectric element 44 in a stand-by state for a non-printing cycle (and in a state where the period of such a stand-by state is relatively short) in the pause period or the printing period. The third driving signal COM 3 is unlikely to change the polarization of the piezoelectric material even if it is applied to the piezoelectric element 44 for a relatively long time and is therefore suitable for the case of a relatively long stand-by duration. In contrast, the second driving signal COM 2 is likely to change the polarization of the piezoelectric material if it is applied to the piezoelectric element 44 for a long time and is therefore suitable for the case of a relatively short stand-by duration. By using the second driving signal COM 2 and the third driving signal COM 3 according to the stand-by duration, power consumption can be reduced while thickening is suppressed effectively.

The second driving signal COM 2 may include a maintenance driving pulse that is called a flushing driving pulse to forcibly remove ink from the nozzles as the driving pulse described above. Thus, flushing is performed by moving the printing head 2 to a flushing point (at which ink is received) in the range in which the printing head 2 can move in the pause period and applying the maintenance driving pulse to the piezoelectric elements 44. From the viewpoint of minimizing the second standard potential Vb2, the waveform of the maintenance driving pulse may protrude upward as with the waveform of the second vibration driving pulse VP2.

Although what is called flexurally vibrating piezoelectric elements 44 are used as pressure generators in the above-described embodiment, the what is called vertically vibrating piezoelectric elements may be used without limitation to the disclosed embodiment. In this instance, the potential varying direction, that is the waveforms, of the driving pulses as illustrated in the above embodiment are upside down. However, the waveform of the second vibration driving pulse VP2 may protrude upward irrespective of what type of piezoelectric generator is used, from the viewpoint of minimizing the second standard potential Vb2.

### 2. 3. Effects

When an image layer is formed by ejecting an ink jet ink composition onto a printing medium from a printing head, the ink jet ink composition, the ink jet printing apparatus, and the ink jet printing method according to the present disclosure ensure high consistency of intermittent ink ejection and high stability in continuous printing and produce images exhibiting both a high fixability and a high rub fastness In addition, since the ink jet ink composition on the printing medium is dried, the printed item as it is can be used as the completed item.

### 3. Examples and Comparative Examples

The subject matter of the present disclosure will be further described in detail with reference to the following Examples and Comparative Examples. However, it is not limited to the Examples, and various modifications may be made unless departing from the scope and spirit of the present disclosure. In the following description, “%” and “part(s)” are on a mass basis unless otherwise specified.

### 3. 1. Synthesis of Urethane Resin Emulsion Preparation of Urethane Resin Emulsion A1

A reaction vessel equipped with a stirrer, a reflux condenser, and a thermometer was charged with 1500 g of a polycarbonate diol NIPPOLAN 964 (produced by (Tosoh Corporation, number average molecular weight: 2000), 220 g of 2,2-dimethylolpropionic acid (DMPA), and 1347 g of methyl ethyl ketone (MEK, boiling point: 79.64° C.) in an atmosphere of flowing nitrogen, and the constituents were heated to 60° C. to dissolve the DMPA. Furthermore, 1300 g of dicyclohexylmethane 4,4′-diisocyanate (MCHDI) and 2.6 g of a urethane catalyst XK-614 (produced by Kusumoto Chemicals) was added. The resulting mixture was heated to 90° C. and subjected a urethanation reaction over a period of 5 hours to yield an isocyanate-terminated prepolymer.

Subsequently, 220 g of triethanolamine was added into the reaction mixture cooled to 80° C., and a 4340 g aliquot of the resulting mixture was taken and added into a mixed solution of 5400 g of water and 22 g of triethanolamine with stirring. Then, 1500 g of ice and, then, 1084 g of 35% by weight bicycloheptanedimethaneamine (BCHDMA) aqueous solution were added for a chain extending reaction. Subsequently, the solvent and water were partially removed to a solid content of 30% by evaporation to yield polycarbonate-based urethane resin emulsion A1 (containing 30% of urethane resin component and 64% of water, acid value: 18 mg KOH/g).

### Preparation of Urethane Resin Emulsion A2

Polycarbonate-based urethane resin emulsion A2 (containing 30% of urethane resin component and 64% of water, acid value: 18 mg KOH/g) was prepared in the same manner as in the preparation of urethane resin emulsion A1, except that 1300 g of dicyclohexylmethane 4,4′-diisocyanate (MCHDI) was replaced with 1100 g of isophorone diisocyanate (IPDI).

### Preparation of Urethane Resin Emulsion A3

Polycarbonate-based urethane resin emulsion A3 (containing 30% of urethane resin component and 64% of water, acid value: 18 mg KOH/g) was prepared in the same manner as in the preparation of urethane resin emulsion A1, except that 1300 g of dicyclohexylmethane 4,4′-diisocyanate (MCHDI) was replaced with 950 g of 1,3-bis(isocyanatomethyl)cyclohexane (BIMCH).

### Preparation of Urethane Resin Emulsion A4

Polycarbonate-based urethane resin emulsion A4 (containing 30% of urethane resin component and 64% of water, acid value: 18 mg KOH/g) was prepared in the same manner as in the preparation of urethane resin emulsion A1, except that 1300 g of dicyclohexylmethane 4,4′-diisocyanate (MCHDI) was replaced with 2000 g of polyisocyanate BURNOCK DN-992-S (produced by DIC).

### 3. 2. Synthesis of Acrylic Resin Emulsion and Styrene-Acrylic Resin Emulsion

### Preparation of Acrylic Resin Emulsion B1

A reaction vessel equipped with a stirrer, a thermometer, a cooler, and a nitrogen gas-delivering device was charged with 173 parts of water, 1 part of a surfactant Emulsogen EPA073 (non-reactive anionic surfactant) in an atmosphere of flowing nitrogen, produced by Clariant), followed by stirring for dissolution. The resulting solution was heated to 80° C. Into the solution was added 13 g of 3% potassium persulfate and a 10% aliquot of a monomer emulsion, which was prepared by adding monomers consisting of 700 g of methyl acrylate (MA), 100 g of hydroxyethyl acrylate (HEA), and 50 g of butyl acrylate (BA) into the solution of 35 g of emulsifier (nonionic surfactant EMULGEN 1118S-70 produced by Kao) in 400 g of water, followed by stirring. Subsequently, 53 parts of 3% potassium persulfate and the rest (90% aliquot) of the monomer composition were dropped over a period of 3 hours and 30 minutes to promote the polymerization reaction with the temperature maintained at 80° C. After dropping, the reaction was conducted for 80 minutes.

Then, 9 g of 3% potassium persulfate and monomers consisting of 24 g of methyl acrylate (MA) and 48 g of methacrylic acid (MAA) were simultaneously added to start polymerization. After adjusting the pH of the reaction mixture to pH 7.5 with 10% sodium hydroxide aqueous solution, the reaction mixture was aged for 3 hours by the reaction. Subsequently, the reaction mixture was cooled to room temperature, and 5 g of a preservative Proxel XL-2 (produced by (produced by Lonza) was added to yield acrylic resin emulsion B1 (solid content: 30%, average particle size: 80 nm, acid value of the resin: 28 mg KOH/g, glass transition temperature: 15° C.) for an aqueous ink jet ink composition. Preparation of Acrylic Resin Emulsion B2

Styrene-acrylic resin emulsion B2 for an aqueous ink jet ink composition (solid content: 30%, average particle size: 90 nm, acid value of the resin: 28 mg KOH/g, glass transition temperature: 10° C.) was prepared in the same manner as in the preparation of acrylic resin emulsion B1, except that the monomers consisting of 700 g of methyl acrylate (MA), 100 g of hydroxyethyl acrylate (HEA), and 50 g of butyl acrylate (BA) were replaced with monomers consisting of 450 g of methyl acrylate (MA), 100 g of benzyl acrylate (BzA), 100 g of hydroxyethyl acrylate (HEA), and 150 g of butyl acrylate (BA).

### Preparation of Styrene-Acrylic Resin Emulsion C1

Styrene-acrylic resin emulsion C1 for an aqueous ink jet ink composition (solid content: 30%, average particle size: 80 nm, acid value of the resin: 28 mg KOH/g, glass transition temperature: 20° C.) was prepared in the same manner as in the preparation of acrylic resin emulsion B1, except that the monomers consisting of 700 g of methyl acrylate (MA), 100 g of hydroxyethyl acrylate (HEA), and 50 g of butyl acrylate (BA) were replaced with monomers consisting of 450 g of methyl acrylate (MA), 100 g of styrene (St), 100 g of hydroxyethyl acrylate (HEA), and 150 g of butyl acrylate (BA).

### Preparation of Styrene-Acrylic Resin Emulsion C2

Styrene-acrylic resin emulsion C2 for an aqueous ink jet ink composition (solid content: 30%, average particle size: 90 nm, acid value of the resin: 28 mg KOH/g, glass transition temperature: 20° C.) was prepared in the same manner as in the preparation of styrene-acrylic resin emulsion C1, except that 48 g of methacrylic acid (MAA) was replaced with 35 g of acrylic acid (AA).

The compositions of urethane resin emulsions A1 to A4 are presented together in the following Table 1, and the compositions of acrylic resin emulsions B1 and B2 and styrene-acrylic resin emulsions C1 and C2 are presented together in the following Table 2.

TABLE 1

| | A1 | A2 | A3 | A4 |
|---|---|---|---|---|
| MCHDI | 1300 | — | — | — |
| IPDI | — | 1100 | — | — |
| BIMCH | | | 950 | — |
| DN992-S | | | | 2000 |
| NIPPOLAN 964 | 1500 | 1500 | 1500 | 1500 |
| DMPA | 220 | 220 | 220 | 220 |
| BCHDMA | 1084 | 1084 | 1084 | 1084 |
| XK-614 | 2.6 | 2.6 | 2.6 | 2.6 |

TABLE 2

| | B1 | B2 | C1 | C2 |
|---|---|---|---|---|
| MA | 724 | 474 | 474 | 474 |
| HEA | 100 | 100 | 100 | 100 |
| BA | 50 | 150 | 150 | 150 |
| BzA | — | 100 | | |
| St | — | — | 100 | 100 |
| MMA | 48 | 48 | 48 | — |
| AA | — | — | — | 35 |

### 3. 3. Preparation of Pigment Dispersion Liquids

### Pigment Dispersion Liquid 1

The mixture of 500 g of ion-exchanged water and 15 g of carbon black was stirred in a rocking mill with 1 mm zirconia beads for 30 minutes to preliminarily wet the pigment. Then, 4485 g of ion-exchanged water was further added, and the constituents of the mixture were dispersed in each other with a high-pressure homogenizer HJP-25005 (manufactured by Sugino Machine). The average particle size of the pigment was 110 nm at this time. The resulting dispersion was removed into a high-pressure container.

After a pressure of 3 MPa was applied to the dispersion, 100 ppm ozone water was introduced to the high-pressure container for surface treatment of the pigment particles. Subsequently, the resulting dispersion liquid was adjusted to pH 9.0 with 0.1 mol/L sodium hydroxide aqueous solution, and the solid content of the pigment in the dispersion liquid was adjusted to yield pigment dispersion liquid 1. Pigment dispersion liquid 1 contained self-dispersible pigment having surfaces to which —COONa group was bound, and the pigment content in the dispersion liquid was 30%. Pigment Dispersion Liquid 2

A mixture was prepared by mixing 500 g of carbon black, 1000 g of water-soluble resin, and 14000 g of water. The water-soluble resin was a styrene-acrylic acid copolymer having an acid value of 100 mg OH/g and a weight average molecular weight of 10,000, neutralized with 0.1 mol/L sodium hydroxide aqueous solution. The constituents of the mixture were dispersed in each other for 1 hour in a rocking mill with 1 mm zirconia beads. Then, the mixture underwent centrifugation to remove impurities, followed by filtration through a microfilter with a pore size of 5.0 (manufactured by Millipore) under reduced pressure. Subsequently, the solid content of the pigment was adjusted to yield pigment dispersion liquid 2 having a pH of 9.0. Pigment dispersion liquid 2 contained pigment dispersed with a water-soluble resin (resin dispersant). The pigment content was 30.0%, and the resin content was 15.0%.

### Pigment Dispersion Liquid 3

A reaction vessel equipped with a stirrer, a thermometer, a reflux tube, and a dropping funnel was purged with nitrogen and then charged with 300 parts by mass of methyl ethyl ketone. Into the dropping funnel were added 40 parts by mass of styrene, 40 parts by mass of ethyl methacrylate, 5 parts by mass of lauryl acrylate, 5 parts by mass of lauryl methacrylate, 5 parts by mass of methoxy polyethylene glycol 400 acrylate AM-90G (produced by Shin-Nakamura Chemical), 5 parts by mass of acrylic acid, 0.2 part by mass of ammonium persulfate, and 0.3 part by mass of t-dodecyl mercaptan. These were dropped into the reaction vessel over a period of 4 hours to polymerize a polymer dispersant. Subsequently, methyl ethyl ketone was added into the reaction vessel, and thus, a 40% by mass polymer dispersant solution was prepared.

The styrene-equivalent weight average molecular weight of the polymer dispersant was determined by gel permeation chromatography (GPC) of the polymer dispersant solution with L7100 System (manufactured by Hitachi) using THF as a solvent, and the result was 58000. The polydispersity (Mw/Mn) was 3.1.

A mixture was prepared by mixing 40 parts by mass of the polymer dispersant solution, 30 parts by mass of C.I. Pigment Blue 15:3, Chromofine Blue as a cyan pigment (produced by Dainichiseika Color & Chemicals, hereinafter denoted as “PB15:3”), 100 parts by mass of 0.1 mol/L sodium hydroxide aqueous solution, and 30 parts by mass of methyl ethyl ketone. The mixture was subjected to 8-pass dispersion with Ultimizer 25005 (manufactured by Sugino Machine). Subsequently, 300 parts of ion-exchanged water was added, and the entirety of methyl ethyl ketone and part of water were removed by evaporation using a rotary evaporator. The resulting dispersion liquid was adjusted to pH 9 with 0.1 mol/L sodium hydroxide solution. Then, while the volume average particles size of the cyan pigment was being measured with a particle size distribution analyzer, the dispersion liquid was dispersed until the volume average particle size of the cyan pigment was reduced to 100 nm. The resulting dispersion was filtered through a 3 membrane filter to yield a pigment dispersion liquid having a solid content (the polymer dispersant and the pigment) of 20% by mass.

### 3. 4. Preparation of Ink Jet Ink Compositions Preparation of Inks

### Examples 1 to 18, Comparative Examples 1 to 10

The constituents presented below were mixed and sufficiently stirred, and the resulting mixture was subjected to filtration through a microfilter having a pore size of 5.0 μm (manufactured by Millipore) under reduced pressure. Thus, ink jet ink compositions of the Examples and Comparative Examples were prepared. Tables 3 and 4 present the constituents and the contents thereof in the ink jet ink compositions of the Examples and Comparative Examples. The solid content of pigment (pigment and pigment dispersant resin) presented in Tables 3 and 4 is a net amount. Also, Tables 3 and 4 present net solid contents of polymer particles produced from each of the above-prepared resin emulsions.

TABLE 3

| | Example | | | | | | | | | | | | | |
|---|---|---|---|---|---|---|---|---|---|---|---|---|---|---|
| Table 3: | 1 | 2 | 3 | 4 | 5 | 6 | 7 | 8 | 9 | 10 | 11 | 12 | 13 | 14 |
| Printing | OPP | OPP | OPP | OPP | OPP | OPP | OPP | OPP | OPP | OPP | OPP | OPP | PET | PET |
| medium | | | | | | | | | | | | | | |
| Pigment | 4.0 | — | — | 4.0 | — | — | 4.0 | — | — | 4.0 | — | — | 4.0 | |
| dispersion | | | | | | | | | | | | | | |
| liquid 1 | | | | | | | | | | | | | | |
| Pigment | — | 4.0 | — | — | 4.0 | — | — | 4.0 | — | — | 4.0 | — | — | 4.0 |
| dispersion | | | | | | | | | | | | | | |
| liquid 2 | | | | | | | | | | | | | | |
| Pigment | — | — | 4.0 | — | — | 4.0 | — | — | 4.0 | — | — | 4.0 | — | — |
| dispersion | | | | | | | | | | | | | | |
| liquid 3 | | | | | | | | | | | | | | |
| A1 | 2.0 | — | — | — | — | — | — | — | 3.0 | — | — | — | 2.0 | — |
| A2 | — | 2.0 | — | — | — | — | — | — | — | 3.0 | — | — | — | 2.0 |
| A3 | — | — | 2.0 | — | — | — | — | — | — | — | 3.0 | — | — | — |
| A4 | — | — | — | 2.0 | — | — | — | — | — | — | — | 3.0 | — | — |
| B1 | — | — | — | — | 2.0 | — | — | — | — | — | — | — | — | — |
| B2 | — | — | — | — | — | 2.0 | — | — | — | — | — | — | — | — |
| C1 | — | — | — | — | — | — | 2.0 | — | — | — | — | — | — | — |
| C2 | — | — | — | — | — | — | — | 2.0 | — | — | — | — | — | — |
| 1,2-HD | 1.5 | 1.5 | 1.5 | 1.5 | 1.5 | 1.5 | 1.5 | 1.5 | 2.5 | 2.0 | 1.0 | 1.0 | 1.5 | 1.5 |
| PG | 1.0 | 1.0 | 1.0 | 1.0 | 2.0 | 2.0 | 1.5 | 1.0 | 1.5 | 2.0 | 3.5 | 1.0 | 1.0 | 1.0 |
| PD501 | 0.5 | 0.5 | 0.5 | 0.5 | 0.5 | 0.5 | 0.5 | 0.5 | 0.5 | 0.5 | 0.5 | 0.5 | 0.5 | 0.5 |
| TEA | 0.3 | 0.3 | 0.3 | 0.3 | 0.3 | 0.3 | 0.3 | 0.3 | 0.3 | 0.3 | 0.3 | 0.3 | 0.3 | 0.3 |
| EDTA | 0.02 | 0.02 | 0.02 | 0.02 | 0.02 | 0.02 | 0.02 | 0.02 | 0.02 | 0.02 | 0.02 | 0.02 | 0.02 | 0.02 |
| ion- | 90.68 | 90.68 | 90.68 | 90.68 | 89.68 | 89.68 | 90.18 | 90.68 | 88.18 | 88.18 | 87.68 | 90.18 | 90.68 | 90.68 |
| exchanged | | | | | | | | | | | | | | |
| water | | | | | | | | | | | | | | |
| platen | 55.0 | 55.0 | 55.0 | 55.0 | 55.0 | 55.0 | 55.0 | 55.0 | 55.0 | 55.0 | 55.0 | 55.0 | 55.0 | 55.0 |
| temperature | | | | | | | | | | | | | | |
| (° C.) | | | | | | | | | | | | | | |
| Printing | 50.0 | 40.0 | 30.0 | 30.0 | 30.0 | 60.0 | 50.0 | 40.0 | 30.0 | 20.0 | 10.0 | 60.0 | 50.0 | 40.0 |
| speed | | | | | | | | | | | | | | |
| (cm/min) | | | | | | | | | | | | | | |
| Ink dry test | A | A | A | A | B | B | B | A | B | B | B | A | A | A |
| Intermittent | A | A | A | A | A | A | B | B | A | A | A | B | A | A |
| ejection | | | | | | | | | | | | | | |
| consistency | | | | | | | | | | | | | | |
| Continuous | A | A | A | A | A | A | A | B | A | A | A | A | A | A |
| printing | | | | | | | | | | | | | | |
| stability | | | | | | | | | | | | | | |

TABLE 4

| | Example | | | | Comparative Example | | | | | | |
|---|---|---|---|---|---|---|---|---|---|---|---|
| Table 4: | 15 | 16 | 17 | 18 | 1 | 2 | 3 | 4 | 5 | 6 | 7 |
| Printing | OPP | OPP | PET | PET | OPP | OPP | OPP | OPP | OPP | OPP | OPP |
| medium | | | | | | | | | | | |
| Pigment | — | — | — | — | 4.0 | — | — | — | — | — | 4.0 |
| dispersion | | | | | | | | | | | |
| liquid 1 | | | | | | | | | | | |
| Pigment | 4.0 | — | 4.0 | — | — | 4.0 | — | 4.0 | — | — | — |
| dispersion | | | | | | | | | | | |
| liquid 2 | | | | | | | | | | | |
| Pigment | — | 4.0 | — | 4.0 | — | — | 4.0 | — | 4.0 | 4.0 | — |
| dispersion | | | | | | | | | | | |
| liquid 3 | | | | | | | | | | | |
| A1 | — | — | — | — | 2.0 | — | — | — | — | 3.0 | — |
| A2 | — | — | — | — | — | 2.0 | — | — | — | — | 3.0 |
| A3 | 3.0 | — | 3.0 | — | — | — | 2.0 | — | — | — | — |
| A4 | — | 3.0 | — | 3.0 | — | — | — | — | — | — | — |
| B1 | — | — | — | — | — | — | — | 2.0 | — | — | — |
| B2 | — | — | — | — | — | — | — | — | 2.0 | — | — |
| C1 | — | — | — | — | — | — | — | — | — | — | — |
| C2 | — | — | — | — | — | — | — | — | — | — | — |
| 1,2-HD | 2.0 | 1.0 | 2.0 | 1.0 | 2.5 | 2.5 | 2.5 | 2.5 | 3.5 | 1.0 | 1.0 |
| PG | 1.0 | 1.0 | 1.0 | 1.0 | 4.0 | 4.0 | 4.0 | 6.0 | 5.0 | 5.0 | 5.0 |
| PD501 | 0.5 | 0.5 | 0.5 | 0.5 | 0.5 | 0.5 | 0.5 | 0.5 | 0.5 | 0.5 | 0.5 |
| TEA | 0.3 | 0.3 | 0.3 | 0.3 | 0.3 | 0.3 | 0.3 | 0.3 | 0.3 | 0.3 | 0.3 |
| EDTA | 0.02 | 0.02 | 0.02 | 0.02 | 0.02 | 0.02 | 0.02 | 0.02 | 0.02 | 0.02 | 0.02 |
| ion- | 89.18 | 90.18 | 89.18 | 90.18 | 86.68 | 86.68 | 86.68 | 84.68 | 84.68 | 86.18 | 86.18 |
| exchanged | | | | | | | | | | | |
| water | | | | | | | | | | | |
| platen | 58.0 | 68.0 | 58.0 | 68.0 | 58.0 | 58.0 | 58.0 | 58.0 | 58.0 | 58.0 | 68.0 |
| temperature | | | | | | | | | | | |
| (° C.) | | | | | | | | | | | |
| Printing | 20.0 | 90.0 | 20.0 | 90.0 | 50.0 | 40.0 | 30.0 | 30.0 | 10.0 | 90.0 | 110.0 |
| speed | | | | | | | | | | | |
| (cm/min) | | | | | | | | | | | |
| Ink dry test | A | A | A | A | C | C | C | D | D | C | C |
| Intermittent | A | A | A | A | B | B | B | A | A | A | A |
| ejection | | | | | | | | | | | |
| consistency | | | | | | | | | | | |
| Continuous | A | A | A | A | A | A | A | A | A | A | B |
| printing | | | | | | | | | | | |
| stability | | | | | | | | | | | |

The materials presented in the Tables are as follows:
1,2-HD: 1,2-hexanediol (normal boiling point: 223° C.)
PG: Propylene glycol (normal boiling point: 188.2° C.)
PD-503A: SILFACE PD-503A (decomposed by heating, no boiling point, polyether-modified silicone surfactant produced by Nissin Chemical Industry)
TEA: Triethanolamine (normal boiling point: 208° C.)
EDTA: Disodium ethylenediaminetetraacetate

### 3. 5. Evaluation

### Examination

Each ink jet ink composition was introduced into an ink cartridge, and the ink cartridge was mounted in an ink jet printing apparatus PX-G930 (manufactured by Seiko Epson) configured to eject ink from a printing head by piezoelectric energy. The printing apparatus PX-G930 was partially modified for film printing and so that the ink jet ink composition can be circulated in the printing head, as shown in FIGS. 4 and 5. Also, the apparatus was modified so that the presence or absence of circulation of the ink composition in the printing head and the circulation amount could be controlled. Furthermore, a platen heater was provided to heat the platen. In each Example, the printing duty of a solid pattern printed under the conditions where one ink droplet having a mass of 28 ng±10% is applied to a unit region of 1/600 inch× 1/600 was defined as 100%. Printing was performed at a temperature of 23° C. and a relative humidity of 55%. A 60 μm-thick OPP film (FOS-AQ, manufacture by Futamura Chemical) and a 50 μm-thick PET film (FE2001, manufactured by Futamura Chemical) were used as the printing medium.

The surface temperature of the printing medium on the platen and the printing speed in each Example were recorded. The printing speed is the speed of the printing medium that is transported, represented by a distance the printing medium is transported per minute. In Examples 16 and 18 and Comparative Example 7, the ink composition was circulated. In these Examples, the printing speed was set high as presented in the Tables. In these Examples, also, the ratio of the amount of the ink composition to be circulated to the maximum amount of ejection from the printing head was set 0.5.

### Dry Test

A printed item including a sold pattern measuring 1.0 inch×0.5 inch printed on a plastic film (OPP plain roll with a thickness of 25 μm, manufactured by Toyobo) with a printing duty of 100% was obtained. The pattern was printed with a dot density of 1440 dpi×1440 dpi. The solid pattern of each printed item was covered with a PPC sheet immediately after printing, and on which a load of 20 g/cm² was placed, followed by standing for 10 minutes. Then, the degree of ink dry was estimated by visually checking how much the ink was transferred to the PPC sheet and evaluated according to the following criteria.

A: PPC sheet was hardly stained.

B: PPC sheet was slightly stained.

C: PPC sheet was stained.

D: PPC sheet was considerably stained.

### Intermittent Ejection Consistency

Ejection consistency in intermittent printing at a temperature of 40° C. and a relative humidity of 20% using the modified PX-G930 was measured. First, it was ensured that the ink jet ink composition was normally ejected through all the nozzles. Then, the ink jet ink composition was ejected onto a A4 photo paper (Photo Glossy Paper manufactured by Seiko Epson). After a 2-minute downtime was taken at a temperature of 40% and a relative humidity of 20%, the ink jet ink composition was ejected again onto the A4 photo paper. In the second ejection, the deviation of the position of a dot first applied on the A4 photo paper from a target position was measured under an optical microscope. Intermittent ejection consistency was rated based on the obtained deviation according to the following criteria.

A: The deviation of the dot from the target position was 10 μm or less.

B: The deviation of the dot from the target position was more than 10 μm.

### Continuous Printing Stability

The ink cartridge of the modified PX-G930 was charged with the ink jet ink composition. A sample in which a cyan solid pattern was printed was created by ejecting the ink jet ink composition onto an A4 photo paper (Photo Glossy Paper manufactured by Seiko Epson) at a resolution of 720 dpi×720 dpi. By repeating such operation at a temperature of 40° C. and a relative humidity of 20% for at most 8 hours, the ink jet ink composition was ejected until ejection of droplets of the ink jet ink composition through nozzles became inconsistent. Continuous printing stability was rated based on the obtained time according to the following criteria.

A: Ejection failure or inconsistent ejection did not occur at all even 8 hours after starting ejection.

B: Ejection failure or inconsistent ejection occurred less than 8 hours after starting ejection.

### 3. 6. Evaluation Results

The ink jet ink compositions of each Example, which contain a pigment, a pigment dispersant resin, polymer particles, and water that account for 95.0% or more of the total mass of the ink jet ink composition produced satisfactory results in the dry test. In contrast, the ink jet ink compositions of each Comparative Example, in which total content of pigment, pigment dispersant resin, polymer particles, and water accounts for less than 95.0% of the total mass of the ink jet ink composition produced poor results.

When the pigment, the pigment dispersant resin, the polymer particles, and water account for 95.0% or more of the total mass, the ink composition can be fully dried with a platen heater and/or a very small heating mechanism, because the content of organic solvent that requires a large amount of energy for drying is low. The results of Examples 16 and 18 suggest that circulation of the ink composition enables high-speed printing even if the platen temperature is increased.

The implementation of the subject matter disclosed herein is not limited to the above-described embodiments, and various modifications may be made. For example, the subject matter disclosed herein may be implemented in substantially the same manner as any of the disclosed embodiments (for example, in terms of function, method, and results, or in terms of purpose and effect). Some elements used in the disclosed embodiments but not essential may be replaced. Implementations capable of producing the same effect as produced in the disclosed embodiments or achieving the same object as in the disclosed embodiments are also within the scope of the subject matter of the present disclosure. A combination of any of the disclosed embodiments with a known art is also within the scope of the subject matter of the present disclosure.

What is claimed is:

1. An ink jet ink composition comprising:
a pigment;
a pigment dispersant resin;
polymer particles; and
water,
wherein the total amount of the pigment, the pigment dispersant resin, the polymer particles, and the water is 95.0% or more of the total mass of the ink jet ink composition.

2. The ink jet ink composition according to claim 1, wherein
the polymer particles contain a resin selected from the group consisting of urethane resin, urea resin, acrylic resin, and styrene-acrylic resin.

3. The ink jet ink composition according to claim 1, further comprising a surfactant with a content of 0.1% to 1.0% relative to the total mass of the ink composition.

4. The ink jet ink composition according to claim 1, further comprising an organic solvent having a boiling point of more than 100.0° C. at 1.0 atmosphere with a content of 0.1% to 5.0% relative to the total mass of the ink composition.

5. The ink jet ink composition according to claim 4, wherein
the organic solvent is 1,2-hexanediol or propylene glycol.

6. The ink jet ink composition according to claim 1, wherein
the ink jet ink composition has a viscosity of 1.0 mPa·s to 3.0 mPa·s at 20.0° C.

7. The ink jet ink composition according to claim 1, wherein
the water has a content of 85.0% or more relative to the total mass of the ink composition.

8. The ink jet ink composition according to claim 1, wherein
the ink jet ink composition is ejected from a printing apparatus including a printing head that has a pressure chamber and a circulation path through which the ink jet ink composition in the pressure chamber is circulated.

9. The ink jet ink composition according to claim 8, wherein
the ink jet ink composition is circulated in an amount of 0.05 to 20.0 relative to a maximum amount of the ink jet ink composition to be ejected from the printing head.

10. The ink jet ink composition according to claim 8, wherein
in-printing micro-vibration or out-of-printing micro-vibration is applied to the ink jet ink composition in the pressure chamber.

11. An ink jet printing method comprising:
ejecting the ink jet ink composition as set forth in claim 1 from a printing head to apply the ink jet ink composition onto a printing medium.

12. An ink jet printing apparatus comprising:
the ink jet ink composition as set forth in claim 1; and
a printing head operable to eject the ink jet ink composition to apply the ink jet ink composition onto a printing medium.

13. The ink jet printing apparatus according to claim 12, further comprising a platen heater.
